(19) United States
(12) Patent Application Publication
(10) Pub. No.: US 2022/0319181 A1
(43) Pub. Date: Oct. 6, 2022

(54) ARTIFICIAL INTELLIGENCE (AI)-BASED SYSTEM AND METHOD FOR MANAGING EDUCATION OF STUDENTS IN REAL-TIME

(71) Applicant: AspectO Technologies Pvt Ltd, Hyderabad (IN)

(72) Inventors: Sujeeth Kanuganti, Hyderabad (IN); Raghuram Vemuganty, Bhopal (IN)

(21) Appl. No.: 17/714,197

(22) Filed: Apr. 6, 2022

Related U.S. Application Data
(60) Provisional application No. 63/171,116, filed on Apr. 6, 2021.

(51) Int. Cl. G06V 20/52; G06K 9/62; G06V 20/40; G09B 5/08; G09B 5/06; G10L 15/26; G10L 15/16; G06V 40/10; G06V 40/16

(52) U.S. Cl. CPC G06V 20/52; G06K 9/6298; G06V 20/46; G09B 5/08; G09B 5/06; G10L 15/26; G10L 15/16; G06V 40/103; G06V 40/174

(57) ABSTRACT

A system and method for managing education of students in real-time is disclosed. The method includes receiving learning data associated with online mode and offline mode of classroom from one or more data capturing devices and media streams and detecting a set of activities. The method further includes classifying the determined set of activities and determining a set of contextual parameters corresponding to the detected set of activities. Further, the method includes identifying one or more learning gaps in one or more students based on the learning data, the set of activities and the set of contextual parameters by using an education management-based AI model in real-time and outputting the set of activities, the set of contextual parameters and the one or more learning gaps on user interface screen of one or more electronic devices.

### EARLIEST PRIORITY DATE

This application claims priority from a Provisional patent application filed in the United States of America having Patent Application No. 63/171,116, filed on Apr. 6, 2021, and titled “EDUCATION ASSESSMENT SYSTEM”.

### FIELD OF INVENTION

Embodiments of the present disclosure relate to Artificial Intelligence (AI) based systems and more particularly relates to an AI-based system and method for managing education of students in real-time.

### BACKGROUND

Today, computer technology has advanced to a great extent and continues to develop in giant steps. The processing, storage, and networking capabilities of modern computing technology are perfectly suited for presenting educational content in an interactive and creative manner In recent times, such collaboration has greatly improved modern education system. In conventional approach, computing systems have been implemented to help students to learn more efficiently. The primary focus of conventional computing systems is only on student's educational development. However, the conventional computing systems at a school or an institute lack efficient features to handle issues such as learning gaps, posture issues with ergonomics, mental health issues, lack of interaction level, falling teaching standards and like. Furthermore, the conventional computing systems lack methods to identify and focus on section of students who need additional attention. The performance of any school or institute would improve immensely if in real-time teachers can help such students.

Hence, there is a need for an improved system and method for managing education of students in real-time, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an Artificial Intelligence (AI) based computing system for managing education of students in real-time is disclosed. The AI-based computing system includes one or more hardware processors and a memory coupled to the one or more hardware processors. The memory includes a plurality of modules in the form of programmable instructions executable by the one or more hardware processors. The plurality of modules include a data receiver module configured to receive learning data associated with at least one of: online mode and offline mode of classroom from at least one of: one or more data capturing devices and media streams. The learning data includes at least one of: one or more real-time images, one or more real-time videos and one or more real-time audios of each of a set of students, one or more teachers and one or more objects and real-time location coordinates of each of the set of students, the one or more teachers and the one or more objects. The plurality of modules also include an activity detection module configured to detect a set of activities performed by each of the set of students and the one or more teachers based on the received learning data by using an education management-based AI model. The plurality of modules includes an activity classification module configured to classify the determined set of activities associated with the set of students in one of: one or more attention activities and one or more non-attention activities based on the received learning data and a set of thresholds by using the education management-based AI model. Further, the plurality of modules include a parameter determination module configured to determine a set of contextual parameters corresponding to the detected set of activities based on the one or more real-time audios associated with the one or more teachers by using the education management-based AI model upon classifying the determined set of activities. The set of contextual parameters include: standard of the set of students, subject, chapter, topic and sub-topic which the one or more teachers are teaching in the classroom. The plurality of modules also include a learning gap identification module configured to identify one or more learning gaps in one or more students among the set of students based on the received learning data, the one or more non-learning activities, the set of activities performed by the one or more teachers and the determined set of contextual parameters by using the education management-based AI model in real-time. The one or more learning gaps correspond to topic clear to students, topic not clear to students, number of the students, contextual parameters and time duration in which the students faced difficulty while learning in the classroom. Furthermore, the plurality of modules include a data output module configured to output the one or more attention activities, the one or more non-attention activities, the determined set of contextual parameters and the identified one or more learning gaps on user interface screen of one or more electronic devices associated with one or more users in real-time. The one or more users include: the one or more teachers and one or more guardians of the one or more students, one or more administrative employees and one or more psychologists

In accordance with another embodiment of the present disclosure, an Artificial Intelligence (AI)-based method for managing education of students in real-time is disclosed. The AI-based method includes receiving learning data associated with at least one of: online mode and offline mode of classroom from at least one of: one or more data capturing devices and media streams. The learning data includes at least one of: one or more real-time images, one or more real-time videos and one or more real-time audios of each of a set of students, one or more teachers and one or more objects and real-time location coordinates of each of the set of students, the one or more teachers and the one or more objects. The AI-based method also includes detecting a set of activities performed by each of the set of students and the one or more teachers based on the received learning data by using an education management-based AI model. The AI-based method further includes classifying the determined set of activities associated with the set of students in one of: one or more attention activities and one or more non-attention activities based on the received learning data and a set of thresholds by using the education management-based AI model. Further, the AI-based method includes determining a set of contextual parameters corresponding to the detected set of activities based on the one or more real-time audios associated with the one or more teachers by using the education management-based AI model upon classifying the determined set of activities. The set of contextual parameters include: standard of the set of students, subject, chapter, topic and sub-topic which the one or more teachers are teaching in the classroom. Also, the AI-based method includes identifying one or more learning gaps in one or more students among the set of students based on the received learning data, the one or more non-learning activities, the set of activities performed by the one or more teachers and the determined set of contextual parameters by using the education management-based AI model in real-time. The one or more learning gaps correspond to topic clear to students, topic not clear to students, number of the students, contextual parameters and time duration in which the students faced difficulty while learning in the classroom. Furthermore, the AI-based method includes outputting the one or more attention activities, the one or more non-attention activities, the determined set of contextual parameters and the identified one or more learning gaps on user interface screen of one or more electronic devices associated with one or more users in real-time. In an embodiment of the present disclosure, the one or more users include the one or more teachers and one or more guardians of the one or more students, one or more administrative employees and one or more psychologists.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for managing education of students in real-time, in accordance with an embodiment of the present disclosure;

FIG. 2 is a block diagram illustrating an exemplary Artificial Intelligence (AI)-based computing system for managing education of students in real-time, in accordance with an embodiment of the present disclosure;

FIGS. 3A-3B are block diagram illustrating an exemplary operation of the AI-based computing system for managing education of students in real-time, in accordance with an embodiment of the present disclosure;

FIG. 4 is a block diagram illustrating an exemplary operation of an emotion determination module for determining one or more emotional issues, in accordance with an embodiment of the present disclosure;

FIG. 5 is a block diagram illustrating an exemplary operation of an interaction management module for determining engagement factor, in accordance with an embodiment of the present disclosure;

FIG. 6 is a block diagram illustrating an exemplary operation of an engagement determination module for determining actual head angle of a set of students, in accordance with an embodiment of the present disclosure;

FIG. 7 is a pictorial depiction depicting determination of actual head angle of the set of students, in accordance with an embodiment of the present disclosure; and

FIG. 8 is a process flow diagram illustrating an exemplary AI-based method for managing education of students in real-time, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

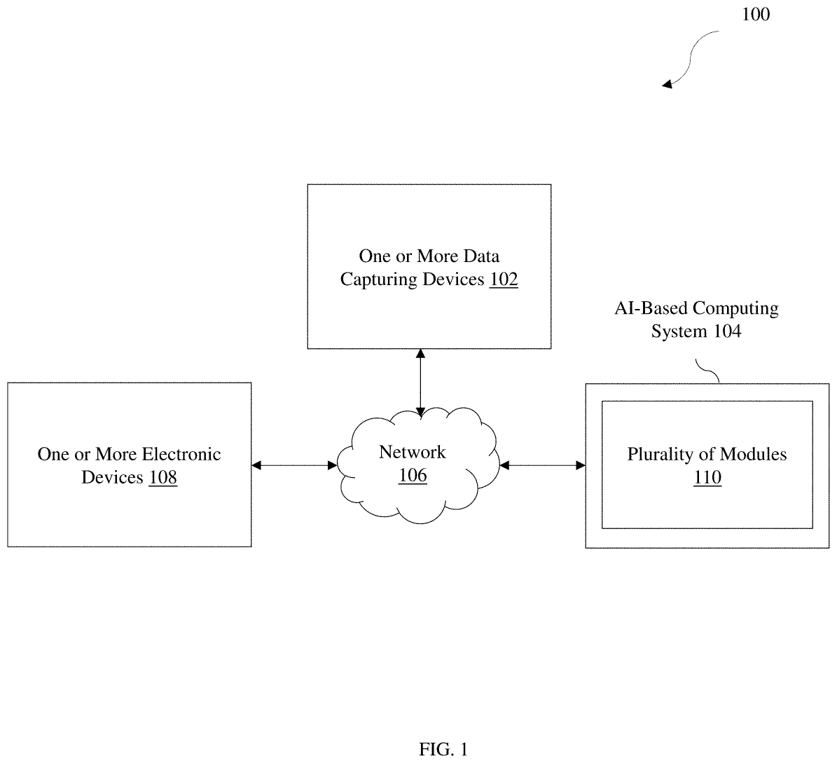

Referring now to the drawings, and more particularly to FIG. 1 through FIG. 8, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for managing education of students in real-time, in accordance with an embodiment of the present disclosure. According to FIG. 1, the computing environment 100 includes one or more data capturing devices 102 communicatively coupled to an Artificial Intelligence (AI)-based computing system 104 via a network 106. In an exemplary embodiment of the present disclosure, the one or more data capturing devices 102 may include a set of cameras, a set of microphones, a Global Positioning System (GPS) device and the like. The one or more data capturing devices 102 may be fixed in classrooms, corridors of an institute or school, and the like. In an embodiment of the present disclosure, the one or more data capturing devices 102 may capture learning data associated with offline mode of classroom. For example, the learning data may include one or more real-time images, one or more real-time videos and one or more real-time audios of each of a set of students, one or more teachers and one or more objects, real-time location coordinates of each of the set of students, the one or more teachers and the one or more objects and the like captured during offline mode of the classroom. For example, the one or more objects may include modals, presentations, charts, black-board and the like. In another embodiment of the present disclosure, the learning data may be captured from media stream during online mode of the examination. The AI-based computing system 104 may be hosted on a central server, such as cloud server or a remote server. Further, the network 106 may be internet or any other wireless network.

Further, the computing environment 100 includes one or more electronic devices 108 associated with one or more users communicatively coupled to the AI-based computing system 104 via the network 106. In an exemplary embodiment of the present disclosure, the one or more users include the one or more teachers and one or more guardians of the one or more students, one or more administrative employees and one or more psychologists. The one or more electronic devices 108 are used by the AI-based computing system 104 to receive the media streams. In an embodiment of the present disclosure, one or more web cams are also used to receive the media streams. The one or more electronic devices 108 may also be used to receive one or more attention activities, one or more non-attention activities, a set of contextual parameters, one or more learning gaps, one or more alerts corresponding to one or more posture issues and one or more corrective measures, a set of emotions, one or more emotional issues, an engagement factor, classified set of students, one or more personalized content, an actual head angle of each of the set of students and one or more recommendations to reduce the one or more learning gaps. In an exemplary embodiment of the present disclosure, the one or more electronic devices 108 may include a laptop computer, desktop computer, tablet computer, smartphone, wearable device, smart watch and the like.

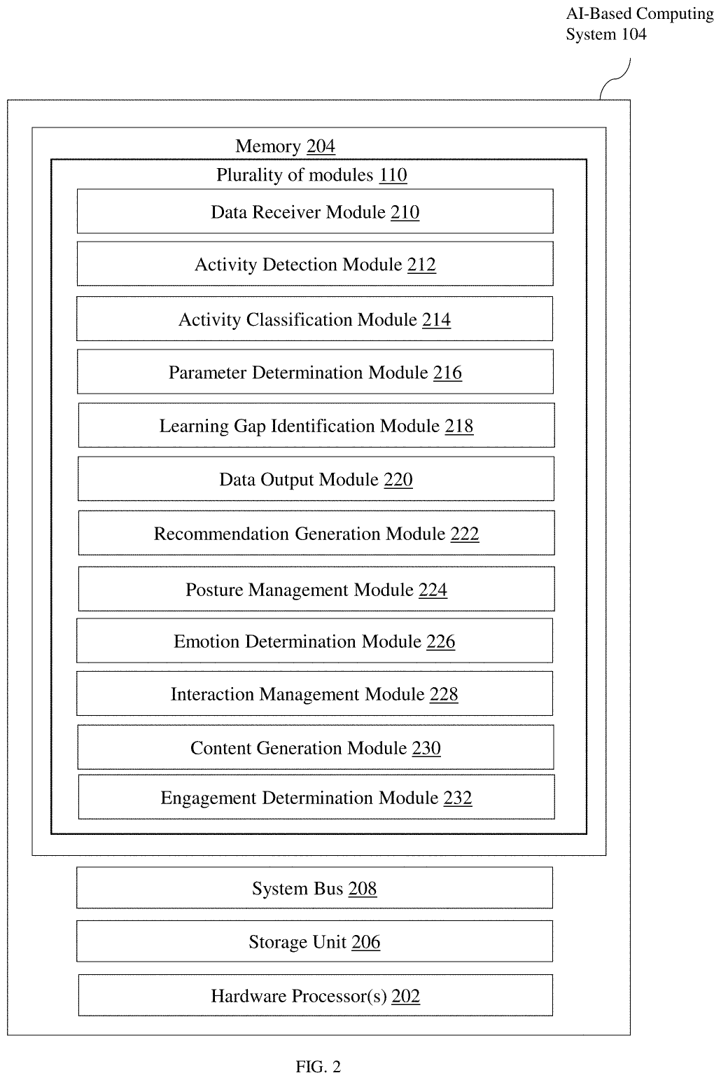

Furthermore, the one or more electronic devices 108 include a local browser, a mobile application or a combination thereof. Furthermore, the one or more users may use a web application via the local browser, the mobile application or a combination thereof to communicate with the AI-based computing system 104. In an embodiment of the present disclosure, the computing system 104 includes a plurality of modules 110. Details on the plurality of modules 110 have been elaborated in subsequent paragraphs of the present description with reference to FIG. 2.

In an embodiment of the present disclosure, the AI-based computing system 104 is configured to receive the learning data associated with the online mode, the offline mode or a combination thereof of the classroom from the one or more data capturing devices 102, the media streams or a combination thereof. Further, the AI-based computing system 104 detects the set of activities performed by each of the set of students and the one or more teachers based on the received learning data by using an education management-based AI model. The AI-based computing system 104 classifies the determined set of activities associated with the set of students in the one or more attention activities or the one or more non-attention activities based on the received learning data and a set of thresholds by using the education management-based AI model. The AI computing system 104 determines the set of contextual parameters corresponding to the detected set of activities based on the one or more real-time audios associated with the one or more teachers by using the education management-based AI model upon classifying the determined set of activities. The AI-based computing system 104 identifies the one or more learning gaps in one or more students among the set of students based on the received learning data, the one or more non-learning activities, the set of activities performed by the one or more teachers and the determined set of contextual parameters by using the education management-based AI model in real-time. Furthermore, the AI-based computing system 104 outputs the one or more attention activities, the one or more non-attention activities, the determined set of contextual parameters and the identified one or more learning gaps on user interface screen of the one or more electronic devices 108 associated with the one or more users in real-time.

FIG. 2 is a block diagram illustrating an exemplary AI-based computing system 104 for managing education of students in real-time, in accordance with an embodiment of the present disclosure. The AI-based computing system 104 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a data receiver module 210, an activity detection module 212, an activity classification module 214, a parameter determination module 216, a learning gap identification module 218, a data output module 220, a recommendation generation module 222, a posture management module 224, an emotion determination module 226, an interaction management module 228, a content generation module 230 and an engagement determination module 232.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit 206 may be a cloud storage. The storage unit 206 may store the received learning data, the set of activities, the one or more attention activities and the one or more non-attention activities. The storage unit may also store the set of contextual parameters, the one or more learning gaps, a set of thresholds, the set of posture parameters, the one or more posture issues, the one or more corrective measures, the set of emotions, the one or more emotional issues, the engagement factor of each of the set of students, the one or more personalized content, the actual head angle of each of the set of students and the one or more recommendations to reduce the one or more learning gaps.

The data receiver module 210 is configured to receive the learning data associated with online mode, offline mode or a combination thereof of classroom from the one or more data capturing devices 102, the media streams or a combination thereof. In an exemplary embodiment of the present disclosure, the one or more data capturing devices 102 may include the set of cameras, the set of microphones, the GPS device and the like, the set of cameras may include one or more teacher cameras facing the one or more teachers, one or more student cameras facing the set of students and the like. The one or more data capturing devices 102 may be fixed in classrooms, corridors of an institute or school, and the like. In an embodiment of the present disclosure, the one or more data capturing devices 102 may capture learning data associated with offline mode of classroom. For example, the learning data may include one or more real-time images, one or more real-time videos and one or more real-time audios of each of a set of students, one or more teachers and one or more objects, real-time location coordinates of each of the set of students, the one or more teachers and the one or more objects and the like captured during offline mode of the classroom. In an embodiment of the present disclosure, the learning data may also include real time test evaluation data for selected students of set of students, attendance details, interaction details of each of the set students, and the like. In an embodiment of the present disclosure, in order to capture the interaction details, audio data is captured via microphones. For example, the one or more objects may include modals, presentations, charts, black-board and the like. In another embodiment of the present disclosure, the learning data may be captured from media streams during online mode of the examination. The one or more electronic devices 108 are used to capture the median streams. In an embodiment of the present disclosure, one or more web cams are also used to receive the media streams. In an exemplary embodiment of the present disclosure, the one or more electronic devices 108 may include a laptop computer, desktop computer, tablet computer, smartphone, wearable device, smart watch and the like. In an embodiment of the present disclosure, the one or more students, the one or more guardians, the one or more teachers and the one or more administrative employees are registered by providing registration details. For example, the one or more students or the one or more guardians for registration provides records representative of personal details such as name, address, and the like. Further, the one or more teachers for registration provides records representative of personal details, subject domain and the like. Furthermore, the one or more administrative employees for registration provides personal details, official details and the like. In one embodiment, the real time images or videos of the set of students are captured during class hours by classroom cameras. In another embodiment, real time images or videos corresponding to the social behaviour of each of the one or more students is captured by the cameras placed within the campus. In such embodiment, the attendance details of each of the one or more students may be captured by image detection of the respective students. For the process of image detection of the respective students, artificial intelligence-based face detection technique is applied. In an embodiment of the present disclosure, the amount of time each of the one or more students interacts with the one or more teachers during the class hour is captured. Further, to capture the interaction details audio data is captured via microphones.

The activity detection module 212 is configured to detect the set of activities performed by each of the set of students and the one or more teachers based on the received learning data by using the education management-based AI model. In an exemplary embodiment of the present disclosure, the education management-based AI model may be a machine learning model. In an embodiment of the present disclosure, the set of activities are detected on continuous basis from the received learning data at regular intervals. For example, the set of activities performed by each of the set of students may be reading, writing, listening to the one or more teachers, sleeping, talking and the like. The set of activities performed by each of the one or more teachers may be reading, writing on black board, talking and the like. In an embodiment of the present disclosure, the activity detection module 212 may detect the set of activities by analyzing the one or more real-time images and the one or more real-time videos of each of the set of students, the one or more teachers and the one or more objects by using the education management-based AI model.

The activity classification module 214 is configured to classify the determined set of activities associated with the set of students in the one or more attention activities or the one or more non-attention activities based on the received learning data and the set of thresholds by using the education management-based AI model. In an embodiment of the present disclosure, the one or more attention activities are activities in which the set of students are paying attention to the one or more teachers, such as writing, listening to the one or more teachers, reading and the like. The one or more non-attention activities are activities in which the set of students are distracted and not paying attention to the one or more teachers, such as sleeping, talking with other students and the like. In classifying the determined set of activities associated with the set of students in the one or more attention activities or the one or more non-attention activities based on the received learning data and the set of thresholds by using the education management-based AI model, the activity classification module 214 normalizes the detected set of activities by performing normalization technique on the detected set of activities. For example, mean normalization is used in which data points are collected over a configured duration of time by anchoring a time stamp. Further, mean of the set of activities points before and after of anchor i.e., time-period which is configurable, is calculated. Thus, the calculated mean is compared against a threshold to determine activity class as attention or non-attention at the anchor point. In an embodiment of the present disclosure, the set of activities are normalized by analyzing the learning data for 60 seconds to find occurrences of each of interest to check against configured thresholds. In an embodiment of the present disclosure, the normalized set of activities are timestamped to store the normalized set of activities in a timeseries structure in the storage unit. Further, the activity classification module 214 compares the detected set of activities with the set of thresholds parameters by using the education management-based AI model upon normalizing the detected set of activities. Furthermore, the activity classification module 214 classifies the determined set of activities in the one or more attention activities or the one or more non-attention activities based on the received learning data and the result of comparison by using the education management-based AI model.

The parameter determination module 216 is configured to determine the set of contextual parameters corresponding to the detected set of activities based on the one or more real-time audios associated with the one or more teachers by using the education management-based AI model upon classifying the determined set of activities. In an embodiment of the present disclosure, the set of contextual parameters are determined in parallel to detection of the set of activities. In an exemplary embodiment of the present disclosure, the set of contextual parameters include standard of the set of students, subject, chapter, topic and sub-topic which the one or more teachers are teaching in the classroom. For example, the standard of a student may be 10^{th}, subject may be mathematics, chapter may be first, topic may be real numbers and sub-topic may be rational numbers. In an embodiment of the present disclosure, the one or more real-time audios are continuous audio streams, specified time audio recorded from start time to end time or a combination thereof with source timestamp. In determining the set of contextual parameters corresponding to the detected set of activities based on the one or more real-time audios associated with the one or more teachers by using the education management-based AI model upon classifying the determined set of activities, the parameter determination module 216 detects language of teaching used in the one or more real-time audios associated with the one or more teachers by using the education management-based AI model. In an embodiment of the present disclosure, the one or more real-time audios are processed using the education management-based AI model i.e., language detection model, to detect the language of teaching, based on the language using Recurrent Neural Network (RNN) based AI Speech Model. Further, the parameter determination module 216 converts the one or more real-time audios associated with the one or more teachers into Unicode text based on the detected language by using the education management-based AI model. The parameter determination module 216 converts the Unicode text into English text paragraph by using the education management-based AI model. In an embodiment of the present disclosure, Unicode text is converted to English text paragraph by using the education management-based AI model i.e., language translator AI Model. Furthermore, the parameter determination module 216 determines the set of contextual parameters corresponding to the detected set of activities based on the English text paragraph by using the education management-based AI model. The set of contextual parameters are stored in a storage unit with source timestamps in the one or more real-time audios associated with the one or more teachers. In an embodiment of the present disclosure, the set of contextual parameters are determined in accordance with the timestamps associated with the set of activities, such that the set of contextual parameters are determined for same time duration in which the set of activities are performed. For example, with use of Hierarchical topic classification, topic being taught is detected and stored in the storage unit with source timestamps of tin a continuous audio stream and (start time) t1 or end time (t2) in a periodic audio file.

In an embodiment of the present disclosure, to accurately detect the exact topic being taught, a hierarchical approach is adopted. Metadata like standard and syllabus is configurated in the system ahead of time. For example, this approach is taken for school syllabus and also for general speeches given by any speakers. For a given standard, there are on an average of 7 subjects with each around 10 chapters, 5 topics for chapter and 3 subtopics for a topic. These numbers are based on observation and can vary. On an average of 7*10*5*3=1050 topics are available, to be detected given an input English text paragraph. A direct approach of detecting topic with such huge number of classes is not responsive, error prone and very high compute consumption. To improve accuracy and speed of this detection, the hierarchical approach is adopted. In an embodiment of the present disclosure, the topics are stored in a hierarchical structure with categories of high-level classification and further broken down to detail into 4 to 6 layers. Zero shot text classification of hugging face is used to classify text at each layer. The paragraph is classified with first layer, based on the output, second layer classes are extracted and processed against the same paragraph. This process is repeated by traversing down the hierarchy until leaf node of the hierarchy is reached, resulting in detecting the topic with high accuracy with in under a second. In an embodiment of the present disclosure, module with curriculum is managed in the AI-based computing system 104, curriculum is stored in the storage unit in the hierarchical structure, such as standard->multiple subjects with keywords->multiple chapters with keywords->multiple topics with keywords->multiple subtopics with keywords.

Further, in determining the set of contextual parameters corresponding to the detected set of activities based on the English text paragraph by using the education management-based AI model, the parameter determination module 216 detects the standard of the set of students based on the English text paragraph by using the education management-based AI model. In an embodiment of the present disclosure, the English text paragraph is the input for hierarchical topic classification. Further, the parameter determination module 216 determines the subject of teaching based on the detected standard of the set of students and the English text paragraph by using the education management-based AI model. The parameter determination module 216 detects the chapter of the subject based on the detected standard of the set of students, the English text paragraph and the determined subject by using the education management-based AI model. Furthermore, the parameter determination module 216 detects the topic of the chapter based on the detected standard of the set of students, the English text paragraph, the determined subject and the detected chapter by using the education management-based AI model. The parameter determination module 216 determines the sub-topic associated with the topic based on the detected standard of the set of students, the English text paragraph, the determined subject, the detected chapter and the detected topic by using the education management-based AI model.

The learning gap identification module 218 is configured to identify the one or more learning gaps in one or more students among the set of students based on the received learning data, the one or more non-learning activities, the set of activities performed by the one or more teachers and the determined set of contextual parameters by using the education management-based AI model in real-time. In an embodiment of the present disclosure, the one or more learning gaps correspond to topic clear to students, topic not clear to students, number of the students, contextual parameters, time duration in which the students faced difficulty while learning in the classroom and the like. In identifying the one or more learning gaps in the one or more students based on the received learning data, the one or more non-learning activities, the set of activities performed by the one or more teachers and the determined set of contextual parameters by using the education management-based AI model in real-time, the learning gap identification module 218 correlates the one or more non-learning activities with the determined set of contextual parameters by using the education management-based AI model. Further, the learning gap identification module 218 identifies the one or more learning gaps in the one or more students based on the received learning data, the set of activities performed by the one or more teachers and result of correlation by using the education management-based AI model in real-time. In an embodiment of the present disclosure, the set of activities detected within the range of the start time to the end time are associated with the detected set of contextual parameters and stored in the storage. Further, result of association facilitates in determination of learning gaps of the students, such that one or more Call to Action (CAT) activities, such as pop quizzes, assignments and the like, may be created based on the determined learning gaps.

The data output module 220 is configured to output the one or more attention activities, the one or more non-attention activities, the determined set of contextual parameters and the identified one or more learning gaps on user interface screen of one or more electronic devices 108 associated with one or more users in real-time. In an exemplary embodiment of the present disclosure, the one or more users include the one or more teachers and one or more guardians of the one or more students, one or more administrative employees, one or more psychologists and the like. In an embodiment of the present disclosure, one or more attention activities, the one or more non-attention activities, the determined set of contextual parameters and the identified one or more learning gaps are outputted on the user interface screen in the form of word document format, presentation format, and the like.

In an embodiment of the present disclosure, the learning data is analysed individually by implementation of one or more machine learning models, such as facial recognition models, facial detection models, head orientation models, body orientation models, gesture detection models, drowsiness detection models, eye state detection models, emotion detection models, object detection models, pattern recognition models, and the like.

The recommendation generation module 222 is configured to detect one or more reasons for the one or more non-attention activities based on the received learning data, the one or more non-learning activities, the set of activities performed by the one or more teachers, the determined set of contextual parameters and a set predefined attention rules by using the education management-based AI model. For example, the set of predefined attention rule may be that when the one or more students are looking at each other for a predefined amount of time, the one or more students are talking to each other. In an exemplary embodiment of the present disclosure, the one or more reasons include talking with students, confused, sleeping, playing in the classroom, over-choice of learning aid, social skill level and behavioural patterns of each of set of the one or more students, Statement of Procedures (SOPs), performance details of each of the one or more teachers and the like. In an exemplary embodiment of the present disclosure, the social skill level and behavioral patterns include conversation with peers, conversation with teachers, emotions in conversations, ability to show empathy and the like. For example, the one or more behavioral patterns include maintaining eye contacts, using props, bullying other students, nature of distractions, such as talking, sleeping and the like. Further, the recommendation generation module 222 generates one or more recommendations to reduce the one or more learning gaps based on the received learning data, the one or more non-learning activities, the set of activities performed by the one or more teachers, the determined set of contextual parameters, predefined recommendation information and the detected one or more reasons by using the education management-based AI model in real-time. In an exemplary embodiment of the present disclosure, the one or more recommendations include changing pedagogy, training the one or more teachers, sharing the detected one or more reasons with the one or more users, generating a customized content for the one or more students, assigning learning priority to each of the set of students based on the one or more learning gaps and the like. For example, the customized content may be assignments, a set of contextual questions and quizzes based on the engagement factor, contextual subject audio, video and text, learning data and the like generated for reducing the one or more learning gaps. The learning priority is assigned to each of the set of students, such that the one or more teachers may pay more attention to weak students.

In an embodiment of the present disclosure, people in a classroom or at work or any place, with long haul sitting or standing or some posture of body, get into issues related to that ergonomics. The posture management module 224 detects the set of posture parameters associated with the set of students and the one or more teachers based on the received data by using the education management-based AI model. In an embodiment of the present disclosure, the set of posture parameters are detected on a continuous basis. In an embodiment of the present disclosure, the posture management module 224 may detect the set of posture parameters by analyzing the one or more real-time images and the one or more real-time videos of each of the set of students and the one or more teachers captured from one or more cameras placed methodically by using the education management-based AI model. In an exemplary embodiment of the present disclosure, the set of posture parameters include neck bend, spine bend, bend in standing position, bend in walking position, arm bend angle, wrist bend angle, viewing distance from electronic screens, break count, duration and the like. In an embodiment of the present disclosure, each of the set of posture parameters are timestamped and stored in the storage unit. Further, the posture management module 224 determines the one or more posture issues with ergonomics of the set of students and the one or more teachers based on the detected set of postures and a set of predefined posture rules by using the education management-based AI model in real-time. In an embodiment of the present disclosure, the one or more posture issues are poses that are bound to create ergonomic related health issues. For example, the one or more posture issues may be slouching, slumping and the like. The posture management module 224 determines one or more corrective measures corresponding to the one or more issues based on the determined one or more posture issues and predefined corrective information by using the education management-based AI model. In an exemplary embodiment of the present disclosure, the one or more corrective measures include correcting the pose, taking a walk break, performing one or more actions and the like. Furthermore, the posture management module 224 generates one or more alerts corresponding to the determined one or more posture issues and the determined one or more corrective measures in real-time. In an embodiment of the present disclosure, the generated one or more alerts are outputted on user interface screen of the one or more electronic devices 108 associated with the one or more users. In an embodiment of the present disclosure, one or more responses of the set of students and the one or more teachers are recorded for escalation when the one or more corrective measures are not taken. The one or more responses are recorded to take actions upon it, such as calling guardians of the students, notifying management about not performing the one or more corrective measures and the like.

In an embodiment of the present disclosure, people in a classroom or at work or any place, go through various kinds of emotions. The emotion determination module 226 detects a set of emotions associated with each of the set of students based on the received learning data by using the education management-based AI model. In an embodiment of the present disclosure, the set of emotions are detected on a continuous basis in real-time. In an embodiment of the present disclosure, the emotion determination module 226 may detect the set of emotions by analyzing the one or more real-time images, the one or more real-time videos and the one or more videos of each of the set of students captured by the one or more cameras placed methodically by using the education management-based AI model. In an exemplary embodiment of the present disclosure, the set of emotions include happy, sad, anger, contempt, disgust, fear, surprise, cry, laugh, scared, confusion, excitement and the like. In an embodiment of the present disclosure, the set of emotions are timestamped and stored in the storage unit. Further, the emotion determination module 226 determines the one or more emotional issues associated with the detected set of issues based on the received learning data, the detected set of emotions and a set of predefined emotion rules by using the education management-based AI model in real-time. In an embodiment of the present disclosure, the one or more emotional issues are emotions which are bound to create health issues among students. For example, the one or more emotional issues include anxiety disorder, behavioral and emotional disorders, bipolar affective disorder, depression and the like. Furthermore, the emotion determination module 226 outputs the detected set of emotions and the determined one or more emotional issues on user interface screen of the one or more electronic devices 108 associated with the one or more users in real-time.

Further, engagement is a key for effective education system. A well engaged class, well engaged student always outperforms and turns out to be more confident. The interaction management module 228 identifies the set of students and the one or more teachers in the one or more real-time images, the one or more real-time videos, the one or more real-time audios or any combination thereof of each of the set of students and the one or more teachers by using the education management-based AI model. Further, the interaction management module 228 identifies the one or more objects in the one or more real-time images, the one or more real-time videos or a combination thereof of the one or more objects by using the education management-based AI model. In an exemplary embodiment of the present disclosure, the one or more objects comprise modals, presentations, charts, black board and the like. Further, the interaction management module 228 converts the one or more real-time audios into a set of keywords by using the education management-based AI model. In an embodiment of the present disclosure, the one or more real-time audios are processed to extract the set of keywords using RNN based AI Models, speech to text engines and the like. The interaction management module 228 determines the set of interaction parameters based on the received learning data, the identified set of students, the identified one or more teachers, the set of keywords and the identified one or more objects by using the education management-based AI model. In an exemplary embodiment of the present disclosure, the set of interaction parameters include number of questions asked by the one or more teachers, number of students who tried to answer, a set of responses of questions received from the set of students, number of students who raised hand, set of emotions associated with each of the set of students, action performed by the set of students, the set of activities performed by the one or more teachers, number of responses that are relevant, number of student names called by the one or more teachers, duration of eye contact, number of times students detected on stage i.e., teacher location, facial direction of the set of students and one or more teachers, duration of students on stage i.e., teacher location and the like. In an embodiment of the present disclosure, video and images are processed using Convolutional Neural Network (CNN) based AI Models to detect information of interest, such as the set of interaction parameters. For example, the actions performed by the set of students may be sleeping, talking and the like. The interaction management module 228 determines engagement factor of each of the set of students by assigning a score and weightage to each of the determined set of interaction parameters based on a set of predefined interaction rules by using the education management-based AI model in real-time. Further, the interaction management module 228 classifies each of the set of students in one or more engagement categories based on the determined engagement factor and predefined engagement information in real-time. The predefined engagement information corresponds a pre-decided benchmark set by an educational institute to classify each of the set of students in the one or more engagement categories. In an exemplary embodiment of the present disclosure, the one or more engagement categories include low engagement, high engagement, average engagement and the like. In an embodiment of the present disclosure, the determined engagement factor and the classified set of students are outputted on user interface screen of the one or more electronic devices 108 associated with the one or more users in real-time. For example, the one or more teachers are notified about low engaged students to call to action. The is action is subsequently verified for a name call of the person student of interest. In an embodiment of the present disclosure, the engagement factor provides information about subject weakness of individual students and is also vital to understand weakness of incorporated education facility. In an embodiment of the present disclosure, red flag cases such as, abnormal social interactions, distress, bullying, and the like are determined based on the one the set of interaction parameters by using the education management-based AI model.

In an embodiment of the present disclosure, the real time images or videos of each of the set of students via webcams in the online mode or the classroom cameras is analysed by machine learning models to identify the engagement factor of each of the one or more students. In such embodiment, real time test evaluation data for selected students of the one or more students provide added details of the engagement factor of such selected students. In another embodiment, the analysis of the interaction details of each of the set of students provides information about subject weakness.

The content generation module 230 is configured to generate one or more personalized content for each of one or more students with low engagement based on the set of interaction parameters, the determined engagement factor and a set of predefined content information by using the education management-based AI model. In an exemplary embodiment of the present disclosure, the one or more personalized content include assignment, study material, a set of contextual questions and quizzes based on the engagement factor, contextual subject audio, video and text and the like. In an embodiment of the present disclosure, the one or more personalized content is generated to improve subject weakness of students. Further, the one or more personalized content may be used by each of the one or more teachers to understand pop-quiz questions to be presented to each of the set of students, which helps in reengaging the one or more students back to their learning. Each of the one or more teachers also understands the customization required in the course work to reengage each of the one or more students back to learning. Furthermore, each of the one or more teachers may also evaluate the social skills of each of the one or more students based on the engagement factor.

In an embodiment of the present disclosure, maintaining eye contact with teacher during communication and while listening to lecture with the exception of taking notes is an effective classroom. Head pose of the student with relative to fixed camera is not an ideal information to access attention vs non-attention. In an embodiment of the present disclosure, the engagement determination module 232 measures head orientation of student relative to teachers position in classroom. The engagement determination module 232 is configured to receive a set of images and videos associated with the one or more teachers from one or more teacher cameras. In an embodiment of the present disclosure, the one or more teacher cameras are cameras facing the one or more teachers. Further, the engagement determination module 232 receives a set of images and videos associated with the set of students from one or more student cameras. In an embodiment of the present disclosure, the one or more student cameras are cameras facing the set of students. The set of images and videos associated with the set of students and the set of images and videos associated with the one or more teachers are captured on a time-synced basis to measure relative head pose of student. The engagement determination module 232 determines the set of teacher parameters based on the received set of images and videos associated with the one or more teachers by using the education management-based AI model. In an exemplary embodiment of the present disclosure, the set of teacher parameters include teacher detection, location coordinates of the one or more teachers and the like. The engagement determination module 232 determines a set of student parameters based on the received set of images and videos associated with the set of students by using the education management-based AI model. In an exemplary embodiment of the present disclosure, the set of student parameters include student identity, head orientation angle of the set of students and the like. Furthermore, the engagement determination module 232 calibrates student location 0 deg head orientation angle against angle of teacher location in teacher camera based on the determined set of teacher parameters, the determined set of student parameters and a set of predefined calibration rules. For example, a student's correction angle for straight position is equal to angle of correction from teacher camera. The engagement determination module 232 determines actual head angle of each of the set of students to determine engagement of the student in the classroom based on the determined set of teacher parameters and the determined set of student parameters by using the education management-based AI model upon calibration in real-time. For example, on two separate time synced images, position of the teacher in image is extracted and head pose of student is extracted. Each student location 0 deg head orientation (straight) is calibrated against the angle of teacher location in teacher camera. Student A correction angle for straight position is equal to angle of correction from teacher camera. Using correction angle, actual head angle of the student is determined to figure if student is oriented towards the teacher.

Further, the AI-based computing system 104 enables real time integration of one or more student learning management systems for providing regular feedbacks corresponding to the one or more learning gaps. In an embodiment of the present disclosure, learning content is fetched in real time from the one or more student learning management systems. In one embodiment, an Application Programming Interface (API) based feedback are provided to the one or more student learning management systems corresponding to the subject weakness of each of the set of students. Further, regular feedbacks are provided by implementation of the one or more machine learning models. As used herein, the term “learning management system” refers to a platform that helps instructors or teachers manage and organize educational materials online and conduct online courses.

In an embodiment of the present disclosure, performance of a teacher is determined by comparing engagement levels, adherence to SOPs, discipline levels, and any other parameter set by the administration of the teacher with other teachers teaching the same subject by using the education management-based AI model. In an exemplary embodiment of the present disclosure, the performance may be excellent, average, poor and the like. Thus, performance appraisal becomes more objective and transparent. In an embodiment of the present disclosure, the school administration may define the SOP by providing one or more quality parameters for the teachers on how to conduct classes. For example, the one or more quality parameters may include time spent on instructional aids like black board/props, Q&A sessions, individual interaction with students, and the like. The SOP may be monitored by the AI-based computing system 104, thereby helping the administration in ensuring quality of instruction by the AI-based computing system 104. Further, a feedback, accessible by both the teacher and the administration may be generated by using the education management-based AI model. This feature can also be toggled off if desired.

In operation, knowledge, skill and attitude of a student is analysed while attending a teacher's class. The teacher and the student are registered with the AI-based computing system 104 beforehand. The student's images or videos are captured in real time by classroom cameras. In an embodiment of the present disclosure, interaction details and facial emotions of the student are captured. The classroom cameras also capture the interaction details of the teacher in real time. Further, the captured details associated with the student and the teacher are analysed. For example, the interaction details between student and teacher indicates attentiveness level i.e., engagement factor of the student. The subject weakness of the student may also be detected by such analysis. Furthermore, the type of pop-quiz questions required to improve the student attentiveness level in the class may also be predicted. The teacher may be provided with an improvised timetable for the improvement of student in particular subject domain. All such predicted details may be presented to the teacher or school staff in the word document or any other format. Furthermore, the set of pop-quiz questions are generated by implementing machine learning models. The pop-quiz questions are presented to student for enhancing student attentiveness level. In an embodiment of the present disclosure, subject materials are presented to the student through any personalized student learning management system.

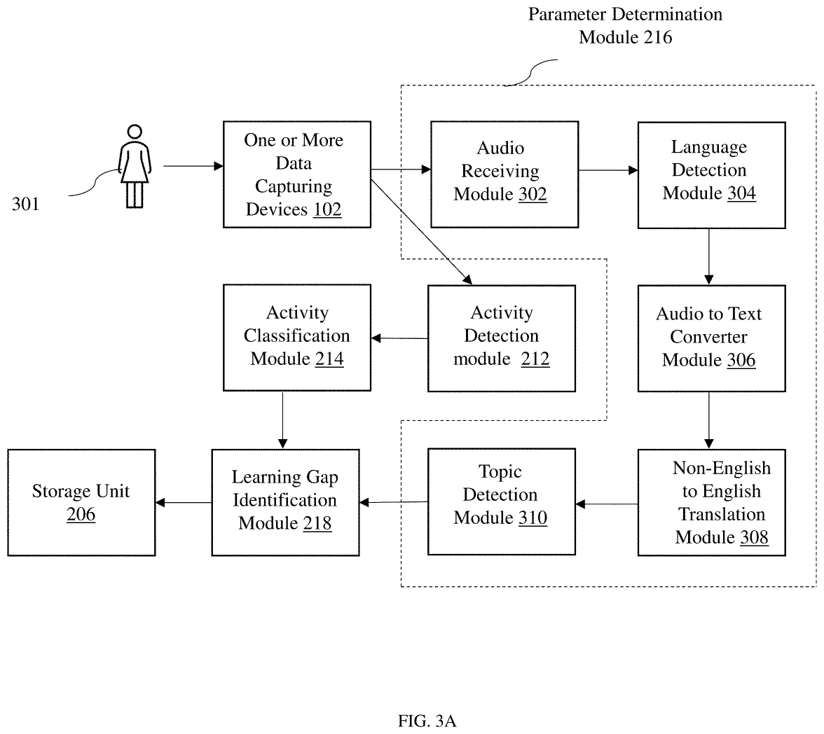

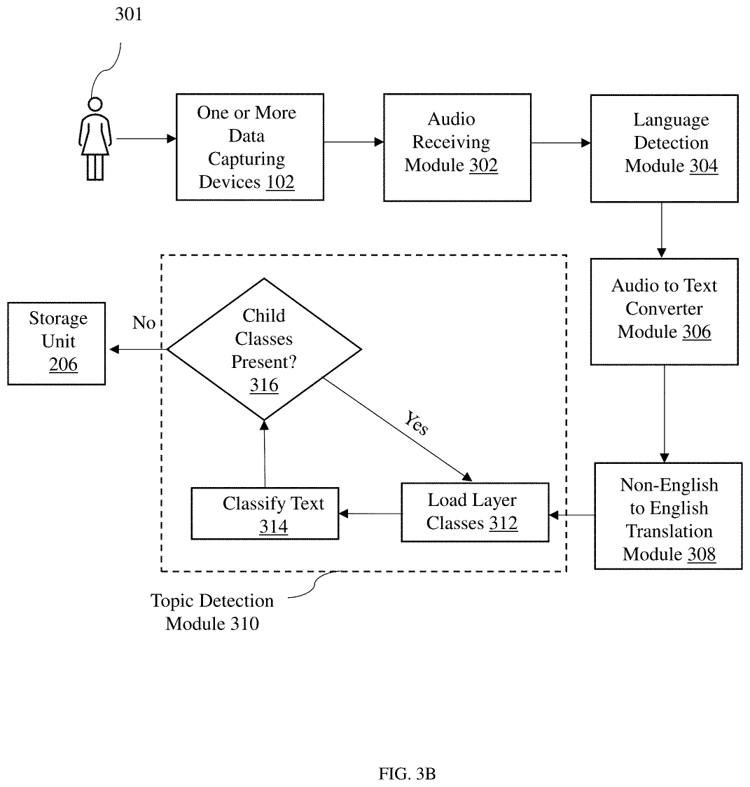

FIGS. 3A-3B are block diagram illustrating an exemplary operation of the AI-based computing system 104 for managing education of students in real-time, in accordance with an embodiment of the present disclosure. In an embodiment of the present disclosure, the one or more real-time images, the one or more real-time videos and the one or more real-time audios of a speaker 301 are captured by the one or more data capturing devices 102. The one or more data capturing devices 102 may be audio and video capturing devices, such as microphones, cameras and the like. In an exemplary embodiment of the present disclosure, the speaker 301 may be the set of students, the one or more teachers and the like. In an embodiment of the present disclosure, the parameter determination module 216 includes audio receiving module 302, language detection module 304, audio to text converter module 306, non-English to English translation module 308 and topic detection module 310. The audio receiving module 302 receives the one or more real-time audios from the one or more data capturing devices 102. In an embodiment of the present disclosure, the one or more real-time audios may be continuous audio batch audio file. Further, the language detection module 304 detects language of teaching used in the one or more real-time audios associated with the one or more teachers by using the education management-based AI model. Further, the audio to text converter module 306 converts the one or more real-time audios associated with the one or more teachers into Unicode text based on the detected language by using the education management-based AI model. The non-English to English translation module 308 converts the Unicode text into English text paragraph by using the education management-based AI model. Furthermore, the topic detection module 310 determines the set of contextual parameters corresponding to the detected set of activities based on the English text paragraph by using the education management-based AI model. The activity detection module 212 is configured to detect the set of activities performed by each of the set of students and the one or more teachers based on the one or more real-time images and the one or more real-time videos by using the education management-based AI model. In an embodiment of the present disclosure, the one or more real-time images and the one or more real-time videos corresponds to continuous video and periodic images. The activity classification module 214 is configured to classify the determined set of activities associated with the set of students in the one or more attention activities or the one or more non-attention activities based on the one or more real-time images, the one or more real-time videos and the set of thresholds by using the education management-based AI model. Further, the learning gap identification module 218 correlates the one or more non-learning activities with the determined set of contextual parameters by using the education management-based AI model. Furthermore, the learning gap identification module 218 identifies the one or more learning gaps in the one or more students based on the received learning data, the set of activities performed by the one or more teachers and result of correlation by using the education management-based AI model in real-time. In an embodiment of the present disclosure, the one or more attention activities, the one or more non-attention activities, the determined set of contextual parameters and the identified one or more learning gaps are stored in the storage unit.

In an embodiment of the present disclosure, in the topic detection module 310, load layer classes 312 classify the English text paragraph at each layer. For example, there may be 4 to 6 layers. The English text paragraph is classified with first layer at 314, based on output, second layer classes are extracted and processed against the same English text paragraph. This process is repeated by traversing down the hierarchy until leaf node of the hierarchy is reached, resulting in detecting the set of contextual parameters with high accuracy with in under a second. At 316, it is determined if child classes are present. If the child classes are present, load layer classes 312 again classify the English text paragraph at 314. If the child classes are not present, the detected set of contextual parameters are stored in the storage unit.

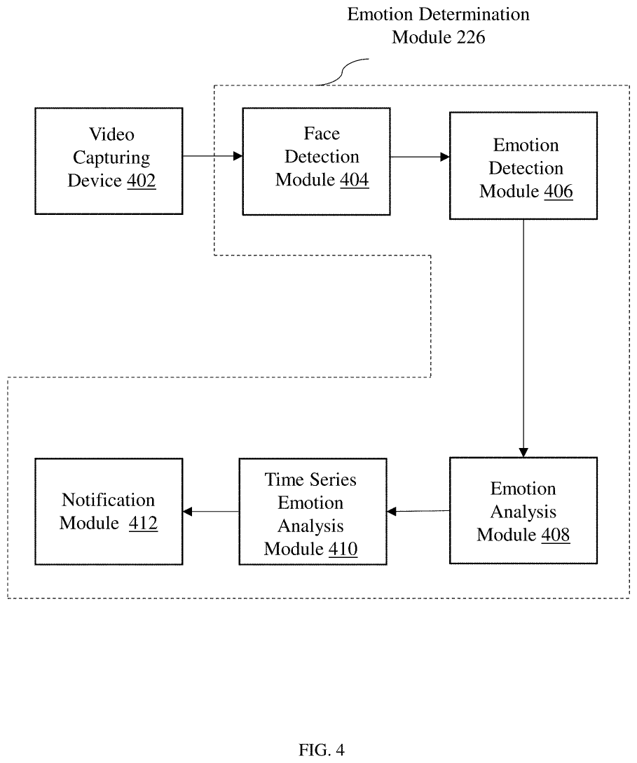

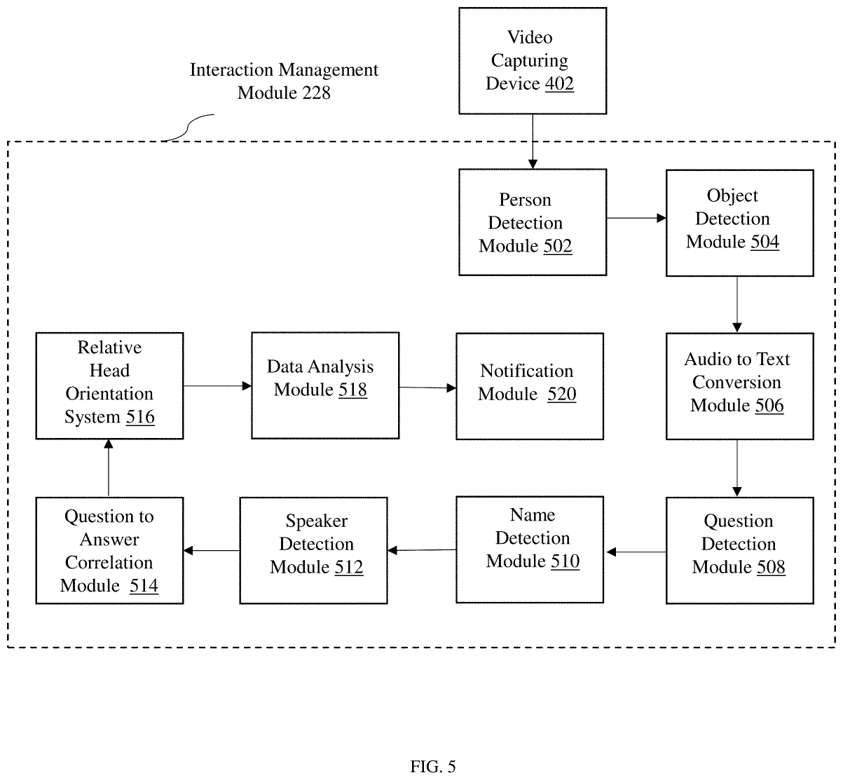

FIG. 4 is a block diagram illustrating an exemplary operation of an emotion determination module 226 for determining one or more emotional issues, in accordance with an embodiment of the present disclosure. In an embodiment of the present disclosure, a video capturing device 402, such as camera one or more cameras capture the one or more real-time images and the one or more real-time videos associated with the set of students. In an exemplary embodiment of the present disclosure, the emotion determination module 226 includes a face detection module 404, an emotion detection module 406, an emotion analysis module 408, a time series emotion analysis module 410 and a notification module 412. The face detection module 404 detects face of the set of students in the one or more real-time images and the one or more real-time videos. Further, the emotion detection module 406 detects the set of emotions associated with each of the set of students based on the received learning data by using the education management-based AI model. In an exemplary embodiment of the present disclosure, the set of emotions include happy, sad, anger, contempt, disgust, fear, surprise, cry, laugh, scared, confusion, excitement and the like. In an embodiment of the present disclosure, the set of emotions are timestamped and stored in the storage unit. Further, the emotion analysis module 408 and the time series emotion analysis module 410 determines the one or more emotional issues associated with the detected set of issues based on the received learning data, the detected set of emotions and the set of predefined emotion rules by using the education management-based AI model in real-time. For example, the one or more emotional issues include anxiety disorder, behavioral and emotional disorders, bipolar affective disorder, depression and the like. In an embodiment of the present disclosure, the set of emotions are timestamped and stored in the storage unit. Furthermore, the notification module 412 associated with emotion determination module 226 outputs the detected set of emotions and the determined one or more emotional issues on user interface screen of the one or more electronic devices 108 associated with the one or more users in real-time.

FIG. 5 is a block diagram illustrating an exemplary operation of an interaction management module 228 for determining one or more emotional issues, in accordance with an embodiment of the present disclosure. In an embodiment of the present disclosure, a video capturing device 402, such as camera one or more cameras capture the one or more real-time images and the one or more real-time videos associated with the set of student. The interaction management module 228 includes a person detection module 502, an object detection module 504, an audio to text conversion module 506, a question detection module 508, a name detection module 510, a speaker detection module 512, a question to answer correlation module 514, a relative head orientation system 516, a data analysis module 518 and a notification module 520. In an exemplary embodiment of the present disclosure, the the one or more real-time images and the one or more real-time videos corresponds to continuous video and periodical images. The person detection module 502 identifies the set of students and the one or more teachers in the one or more real-time images and the one or more real-time videos by using the education management-based AI model. The object detection module 504 identifies the one or more objects, such as modals, presentations, charts, black board and the like in the one or more real-time images and the one or more real-time videos of the one or more objects by using the education management-based AI model. Further, the audio to text conversion module 506 converts the one or more real-time audios into the set of keywords by using the education management-based AI model. The question detection module 508 detects a set of questions asked by the one or more teachers on the one or more real-time audios based on the set of keywords by using the education management-based AI model. Furthermore, the name detection module 510 determines number of students who tried to answer and number of students who raised hand based on the identified set of students and the identified one or more teachers by using the education management-based AI model. The speaker detection module 512 determines name of the students who answered the set of questions based on the identified set of students, the identified one or more teachers and the one or more real-time audios by using the education management-based AI model. The question to answer correlation module 514 correlates correct answer of the set of questions with the answers provided by the students to determine students which provided correct answers and students which provided wrong answers by using the education management-based AI model. Further, the relative head orientation system 516 determines the actual head angle of each of the set of students to determine engagement of the student in the classroom based on the set of teacher parameters and the set of student parameters by using the education management-based AI model. The data analysis module 518 determines the engagement factor of each of the set of students by assigning a score and weightage to each of the determined set of interaction parameters based on a set of predefined interaction rules by using the education management-based AI model in real-time. In an exemplary embodiment of the present disclosure, the set of interaction parameters comprise: number of questions asked by the one or more teachers, number of students who tried to answer, a set of responses of questions received from the set of students, number of students who raised hand, set of emotions associated with each of the set of students, action performed by the set of students, the set of activities performed by the one or more teachers, number of responses that are relevant, number of student names called by the one or more teachers, duration of eye contact, number of times students detected on stage, facial direction of the set of students and one or more teachers and duration of students on stage. Further, the notification module 520 associated with the interaction management module 228 outputs the determined engagement factor on user interface screen of the one or more electronic devices 108 associated with the one or more users in real-time.

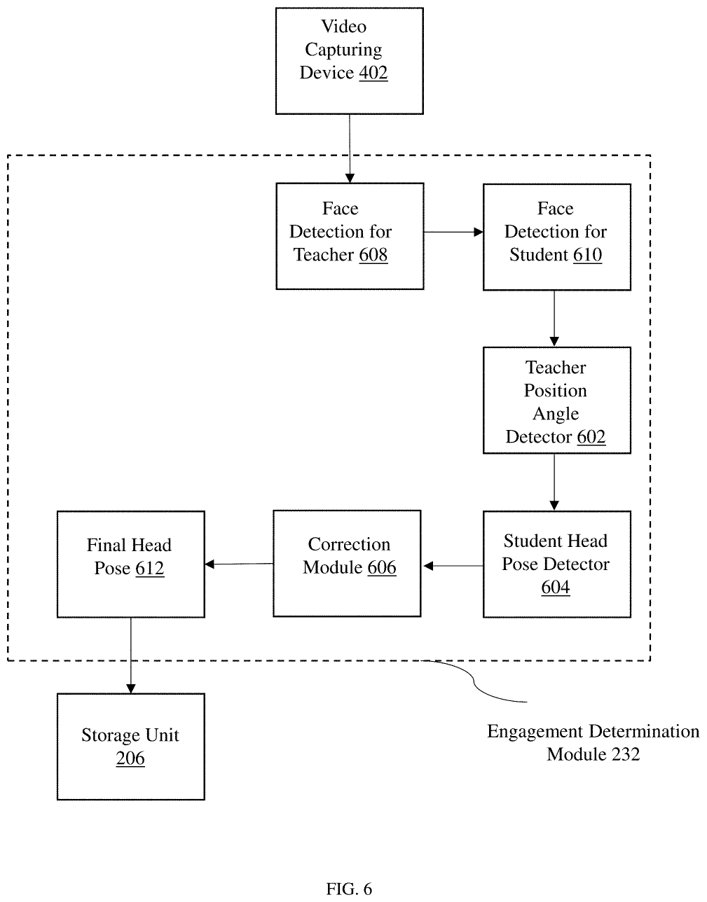

FIG. 6 is a block diagram illustrating an exemplary operation of an an engagement determination module 232 for determining actual head angle of a set of students, in accordance with an embodiment of the present disclosure. In an embodiment of the present disclosure, the video capturing device 402 includes the one or more teacher cameras and the one or more student cameras. In an embodiment of the present disclosure, the engagement determination module 232 includes a teacher position angle detector 602, a student head pose detector 604, and a correction module 606. The engagement determination module 232 receives the set of images and videos associated with the one or more teachers from one or more teacher cameras. Further, the engagement determination module 232 receives the set of images and videos associated with the set of students from one or more student cameras. The set of images and videos associated with the set of students and the set of images and videos associated with the one or more teachers are captured on a time-synced basis to measure relative head pose of student. The engagement determination module 232 performs face detection operation for the one or more teachers 608 to identify the teacher in class. The engagement determination module 232 also performs face detection operation for the set of students 610 to identify each of the set of students in the class. Further, the teacher position angle detector 602 detects the teacher detection and the location coordinates of the one or more teachers based on the received set of images and videos associated with the one or more teachers by using the education management-based AI model. The student head pose detector 604 detects head orientation angle of the set of students based on the received set of images and videos associated with the set of students by using the education management-based AI model. Furthermore, the correction module 606 calibrates student location 0 deg head orientation angle against angle of teacher location in teacher camera based on the determined set of teacher parameters, the determined set of student parameters and a set of predefined calibration rules. The engagement determination module 232 determines actual head angle i.e., final head pose 612 of each of the set of students to determine engagement of the student in the classroom based on the determined set of teacher parameters and the determined set of student parameters by using the education management-based AI model upon calibration in real-time. Further, the actual head angle is stored in the storage unit.

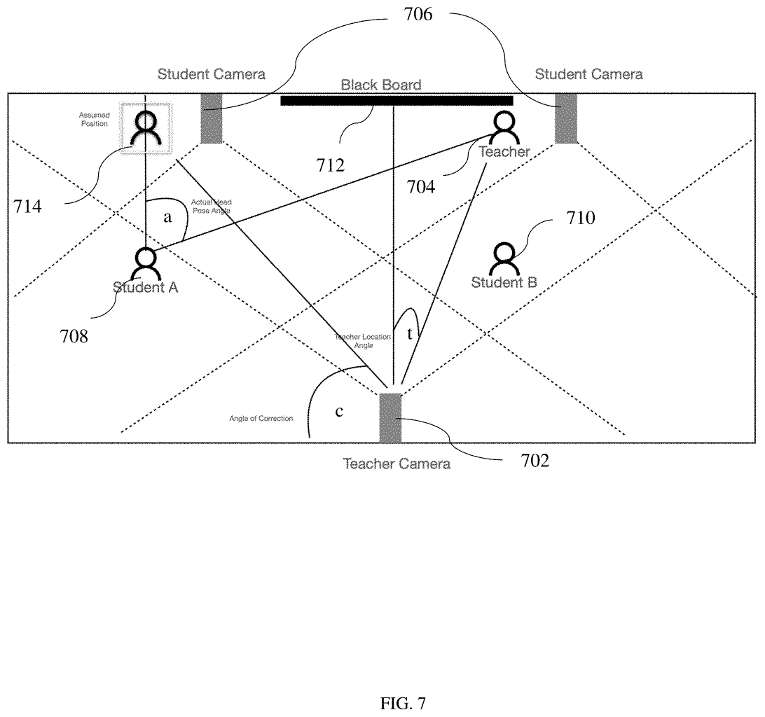

FIG. 7 is a pictorial depiction depicting determination of actual head angle of the set of students, in accordance with an embodiment of the present disclosure. As shown in FIG. 7, the video capturing device 402 includes the one or more teacher cameras 702 for capturing the set of images and videos associated with a teacher 704 and the one or more student cameras 706 the set of images and videos associated with a first student 708 and a second student 710. Further, a black board 712 is placed between the one or more teacher cameras 702 and the one or more student cameras 706. In an embodiment of the present disclosure, the set of images and videos associated with the teacher 704 and the set of images and videos associated with the first student 708 and the second student 710 are time synced images. In an embodiment of the present disclosure, position of the teacher 704 in image is extracted and head pose of student is extracted. Each of the first student's and the second student's location 0-degree head orientation (straight) is calibrated against teacher location angle ‘t’ in the one or more teacher cameras 702. The first student correction angle for straight position is equal to angle of correction ‘c’ from the one or more teacher cameras 702. Using the angle of correction ‘c’, actual head pose angle ‘a’ of the first student 708 is determined if the first student 708 is oriented towards the teacher 704. In an embodiment of the present disclosure, position of the first student 708 is assumed near the student camera called assumed position 714, as shown in FIG. 7.

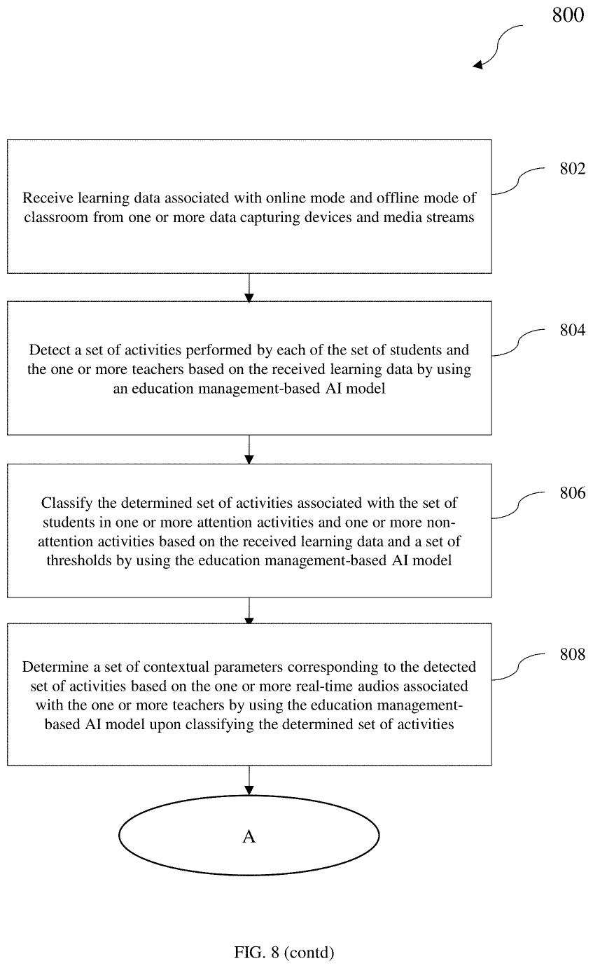

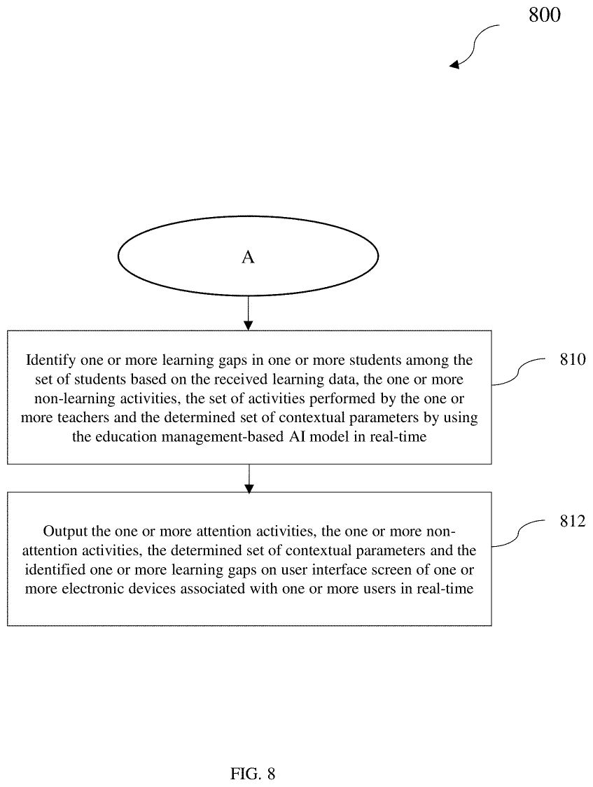

FIG. 8 is a process flow diagram illustrating an exemplary AI-based method for managing education of students in real-time, in accordance with an embodiment of the present disclosure. At step 802, learning data associated with online mode, offline mode or a combination thereof of classroom is received from one or more data capturing devices 102, media streams or a combination thereof. In an exemplary embodiment of the present disclosure, the one or more data capturing devices 102 may include a set of cameras, a set of microphones, a GPS device and the like, the set of cameras may include one or more teacher cameras facing the one or more teachers, one or more student cameras facing the set of students and the like. The one or more data capturing devices 102 may be fixed in classrooms, corridors of an institute or school, and the like. In an embodiment of the present disclosure, the one or more data capturing devices 102 may capture learning data associated with offline mode of classroom. For example, the learning data may include one or more real-time images, one or more real-time videos and one or more real-time audios of each of a set of students, one or more teachers and one or more objects, real-time location coordinates of each of the set of students, the one or more teachers and the one or more objects and the like captured during offline mode of the classroom. In an embodiment of the present disclosure, the learning data may also include real time test evaluation data for selected students of set of students, attendance details, interaction details of each of the set students, and the like. In an embodiment of the present disclosure, in order to capture the interaction details, audio data is captured via microphones. For example, the one or more objects may include modals, presentations, charts, black-board and the like. In another embodiment of the present disclosure, the learning data may be captured from media streams during online mode of the examination. Further, one or more electronic devices 108 are used to capture the median streams. In an embodiment of the present disclosure, one or more web cams are also used to receive the media streams. In an exemplary embodiment of the present disclosure, the one or more electronic devices 108 may include a laptop computer, desktop computer, tablet computer, smartphone, wearable device, smart watch and the like. In an embodiment of the present disclosure, the one or more students, the one or more guardians, the one or more teachers and the one or more administrative employees are registered by providing registration details. For example, the one or more students or the one or more guardians for registration provides records representative of personal details such as name, address, and the like. Further, the one or more teachers for registration provides records representative of personal details, subject domain and the like. Furthermore, the one or more administrative employees for registration provides personal details, official details and the like. In one embodiment, the real time images or videos of the set of students are captured during class hours by classroom cameras. In another embodiment, real time images or videos corresponding to the social behaviour of each of the one or more students is captured by the cameras placed within the campus. In such embodiment, the attendance details of each of the one or more students may be captured by image detection of the respective students. For the process of image detection of the respective students, artificial intelligence-based face detection technique is applied. In an embodiment of the present disclosure, the amount of time each of the one or more students interacts with the one or more teachers during the class hour is captured. Further, to capture the interaction details audio data is captured via microphones.

At step 804, a set of activities performed by each of the set of students and the one or more teachers are detected based on the received learning data by using an education management-based AI model. In an exemplary embodiment of the present disclosure, the education management-based AI model may be a machine learning model. In an embodiment of the present disclosure, the set of activities are detected on continuous basis from the received learning data at regular intervals. For example, the set of activities performed by each of the set of students may be reading, writing, listening to the one or more teachers, sleeping, talking and the like. The set of activities performed by each of the one or more teachers may be reading, writing on black board, talking and the like. In an embodiment of the present disclosure, the set of activities may be detected by analyzing the one or more real-time images and the one or more real-time videos of each of the set of students, the one or more teachers and the one or more objects by using the education management-based AI model.

At step 806, the determined set of activities associated with the set of students are classified in one or more attention activities or one or more non-attention activities based on the received learning data and a set of thresholds by using the education management-based AI model. In an embodiment of the present disclosure, the one or more attention activities are activities in which the set of students are paying attention to the one or more teachers, such as writing, listening to the one or more teachers, reading and the like. The one or more non-attention activities are activities in which the set of students are distracted and not paying attention to the one or more teachers, such as sleeping, talking with other students and the like. In classifying the determined set of activities associated with the set of students in the one or more attention activities or the one or more non-attention activities based on the received learning data and the set of thresholds by using the education management-based AI model, the AI-based method 800 includes normalizing the detected set of activities by performing normalization technique on the detected set of activities. For example, mean normalization is used in which data points are collected over a configured duration of time by anchoring a time stamp. Further, mean of the set of activities points before and after of anchor i.e., time-period which is configurable, is calculated. Thus, the calculated mean is compared against a threshold to determine activity class as attention or non-attention at the anchor point. In an embodiment of the present disclosure, the set of activities are normalized by analyzing the learning data for 60 seconds to find occurrences of each of interest to check against configured thresholds. In an embodiment of the present disclosure, the normalized set of activities are timestamped to store the normalized set of activities in a timeseries structure in the storage unit. Further, the AI-based method 800 includes comparing the detected set of activities with the set of thresholds parameters by using the education management-based AI model upon normalizing the detected set of activities. Furthermore, the AI-based method 800 includes classifying the determined set of activities in the one or more attention activities or the one or more non-attention activities based on the received learning data and the result of comparison by using the education management-based AI model.

At step 808, a set of contextual parameters corresponding to the detected set of activities are determined based on the one or more real-time audios associated with the one or more teachers by using the education management-based AI model upon classifying the determined set of activities. In an embodiment of the present disclosure, the set of contextual parameters are determined in parallel to detection of the set of activities. In an exemplary embodiment of the present disclosure, the set of contextual parameters include standard of the set of students, subject, chapter, topic and sub-topic which the one or more teachers are teaching in the classroom. For example, the standard of a student may be 10^{th}, subject may be mathematics, chapter may be first, topic may be real numbers and sub-topic may be rational numbers. In an embodiment of the present disclosure, the one or more real-time audios are continuous audio streams, specified time audio recorded from start time to end time or a combination thereof with source timestamp. In determining the set of contextual parameters corresponding to the detected set of activities based on the one or more real-time audios associated with the one or more teachers by using the education management-based AI model upon classifying the determined set of activities, the AI-based method 800 includes detecting language of teaching used in the one or more real-time audios associated with the one or more teachers by using the education management-based AI model. In an embodiment of the present disclosure, the one or more real-time audios are processed using the education management-based AI model i.e., language detection model, to detect the language of teaching, based on the language using Recurrent Neural Network (RNN) based AI Speech Model. Further, the AI-based method 800 includes converting the one or more real-time audios associated with the one or more teachers into Unicode text based on the detected language by using the education management-based AI model. The AI-based method 800 includes converting the Unicode text into English text paragraph by using the education management-based AI model. In an embodiment of the present disclosure, Unicode text is converted to English text paragraph by using the education management-based AI model i.e., language translator AI Model. Furthermore, the AI-based method 800 includes determining the set of contextual parameters corresponding to the detected set of activities based on the English text paragraph by using the education management-based AI model. The set of contextual parameters are stored in a storage unit with source timestamps in the one or more real-time audios associated with the one or more teachers. In an embodiment of the present disclosure, the set of contextual parameters are determined in accordance with the timestamps associated with the set of activities, such that the set of contextual parameters are determined for same time duration in which the set of activities are performed. For example, with use of Hierarchical topic classification, topic being taught is detected and stored in the storage unit with source timestamps of t in a continuous audio stream and (start time) t1 or end time (t2) in a periodic audio file.

In an embodiment of the present disclosure, to accurately detect the exact topic being taught, a hierarchical approach is adopted. Metadata like standard and syllabus is configurated in the system ahead of time. For example, this approach is taken for school syllabus and also for general speeches given by any speakers. For a given standard, there are on an average of 7 subjects with each around 10 chapters, 5 topics for chapter and 3 subtopics for a topic. These numbers are based on observation and can vary. On an average of 7*10*5*3=1050 topics are available, to be detected given an input English text paragraph. A direct approach of detecting topic with such huge number of classes is not responsive, error prone and very high compute consumption. To improve accuracy and speed of this detection, the hierarchical approach is adopted. In an embodiment of the present disclosure, the topics are stored in a hierarchical structure with categories of high-level classification and further broken down to detail into 4 to 6 layers. Zero shot text classification of hugging face is used to classify text at each layer. The paragraph is classified with first layer, based on the output, second layer classes are extracted and processed against the same paragraph. This process is repeated by traversing down the hierarchy until leaf node of the hierarchy is reached, resulting in detecting the topic with high accuracy with in under a second. In an embodiment of the present disclosure, curriculum is stored in the storage unit in the hierarchical structure, such as standard->multiple subjects with keywords->multiple chapters with keywords->multiple topics with keywords->multiple subtopics with keywords.

Further, in determining the set of contextual parameters corresponding to the detected set of activities based on the English text paragraph by using the education management-based AI model, the AI-based method 800 includes detecting the standard of the set of students based on the English text paragraph by using the education management-based AI model. In an embodiment of the present disclosure, the English text paragraph is the input for hierarchical topic classification. Further, the AI-based method 800 includes determining the subject of teaching based on the detected standard of the set of students and the English text paragraph by using the education management-based AI model. The AI-based method 800 includes detecting the chapter of the subject based on the detected standard of the set of students, the English text paragraph and the determined subject by using the education management-based AI model. Furthermore, the AI-based method 800 includes detecting the topic of the chapter based on the detected standard of the set of students, the English text paragraph, the determined subject and the detected chapter by using the education management-based AI model. The AI-based method 800 includes determining the sub-topic associated with the topic based on the detected standard of the set of students, the English text paragraph, the determined subject, the detected chapter and the detected topic by using the education management-based AI model.

At step 810, one or more learning gaps are identified in one or more students among the set of students based on the received learning data, the one or more non-learning activities, the set of activities performed by the one or more teachers and the determined set of contextual parameters by using the education management-based AI model in real-time. In an embodiment of the present disclosure, the one or more learning gaps correspond to topic clear to students, topic not clear to students, number of the students, contextual parameters, time duration in which the students faced difficulty while learning in the classroom and the like. In identifying the one or more learning gaps in the one or more students based on the received learning data, the one or more non-learning activities, the set of activities performed by the one or more teachers and the determined set of contextual parameters by using the education management-based AI model in real-time, AI-based method 800 includes correlating the one or more non-learning activities with the determined set of contextual parameters by using the education management-based AI model. Further, the AI-based method 800 includes identifying the one or more learning gaps in the one or more students based on the received learning data, the set of activities performed by the one or more teachers and result of correlation by using the education management-based AI model in real-time. In an embodiment of the present disclosure, the set of activities detected within the range of the start time to the end time are associated with the detected set of contextual parameters and stored in the storage. Further, result of association facilitates in determination of learning gaps of the students, such that one or more Call to Action (CAT) activities, such as pop quizzes, assignments and the like, may be created based on the determined learning gaps.

At step 812, the one or more attention activities, the one or more non-attention activities, the determined set of contextual parameters and the identified one or more learning gaps are outputted on user interface screen of one or more electronic devices 108 associated with one or more users in real-time. In an exemplary embodiment of the present disclosure, the one or more users include the one or more teachers and one or more guardians of the one or more students, one or more administrative employees, one or more psychologists and the like. In an embodiment of the present disclosure, one or more attention activities, the one or more non-attention activities, the determined set of contextual parameters and the identified one or more learning gaps are outputted on the user interface screen in the form of word document format, presentation format, and the like.

In an embodiment of the present disclosure, the learning data is analysed individually by implementation of one or more machine learning models, such as facial recognition models, facial detection models, head orientation models, body orientation models, gesture detection models, drowsiness detection models, eye state detection models, emotion detection models, object detection models, pattern recognition models, and the like.

Further, the AI-based method 800 includes detecting one or more reasons for the one or more non-attention activities based on the received learning data, the one or more non-learning activities, the set of activities performed by the one or more teachers, the determined set of contextual parameters and a set predefined attention rules by using the education management-based AI model. For example, the set of predefined attention rule may be that when the one or more students are looking at each other for a predefined amount of time, the one or more students are talking to each other. In an exemplary embodiment of the present disclosure, the one or more reasons include talking with students, confused, sleeping, playing in the classroom, over-choice of learning aid, social skill level and behavioural patterns of each of set of the one or more students, Statement of Procedures (SOPs), performance details of each of the one or more teachers and the like. In an exemplary embodiment of the present disclosure, the social skill level and behavioral patterns include conversation with peers, conversation with teachers, emotions in conversations, ability to show empathy and the like. For example, the one or more behavioral patterns include maintaining eye contacts, using props, bullying other students, nature of distractions, such as talking, sleeping and the like. Further, the AI-based method 800 includes generating one or more recommendations to reduce the one or more learning gaps based on the received learning data, the one or more non-learning activities, the set of activities performed by the one or more teachers, the determined set of contextual parameters, predefined recommendation information and the detected one or more reasons by using the education management-based AI model in real-time. In an exemplary embodiment of the present disclosure, the one or more recommendations include changing pedagogy, training the one or more teachers, sharing the detected one or more reasons with the one or more users, generating a customized content for the one or more students, assigning learning priority to each of the set of students based on the one or more learning gaps and the like. For example, the customized content may be assignments, a set of contextual questions and quizzes based on the engagement factor, contextual subject audio, video and text, learning data and the like generated for reducing the one or more learning gaps. The learning priority is assigned to each of the set of students, such that the one or more teachers may pay more attention to weak students.

In an embodiment of the present disclosure, the AI-based method 800 includes detecting the set of posture parameters associated with the set of students and the one or more teachers based on the received data by using the education management-based AI model. In an embodiment of the present disclosure, the set of posture parameters are detected on a continuous basis. In an embodiment of the present disclosure, the set of posture parameters are detected by analyzing the one or more real-time images and the one or more real-time videos of each of the set of students and the one or more teachers captured from one or more cameras placed methodically by using the education management-based AI model. In an exemplary embodiment of the present disclosure, the set of posture parameters include neck bend, spine bend, bend in standing position, bend in walking position, arm bend angle, wrist bend angle, viewing distance from electronic screens, break count, duration and the like. In an embodiment of the present disclosure, each of the set of posture parameters are timestamped and stored in the storage unit. Further, the AI-based method 800 includes determining the one or more posture issues with ergonomics of the set of students and the one or more teachers based on the detected set of postures and a set of predefined posture rules by using the education management-based AI model in real-time. In an embodiment of the present disclosure, the one or more posture issues are poses that are bound to create ergonomic related health issues. For example, the one or more posture issues may be slouching, slumping and the like. The AI-based method 800 includes determining one or more corrective measures corresponding to the one or more issues based on the determined one or more posture issues and predefined corrective information by using the education management-based AI model. In an exemplary embodiment of the present disclosure, the one or more corrective measures include correcting the pose, taking a walk break, performing one or more actions and the like. Furthermore, the AI-based method 800 generating one or more alerts corresponding to the determined one or more posture issues and the determined one or more corrective measures in real-time. In an embodiment of the present disclosure, the generated one or more alerts are outputted on user interface screen of the one or more electronic devices 108 associated with the one or more users. In an embodiment of the present disclosure, one or more responses of the set of students and the one or more teachers are recorded for escalation when the one or more corrective measures are not taken. The one or more responses are recorded to take actions upon it, such as calling guardians of the students, notifying management about not performing the one or more corrective measures and the like.

Furthermore, the AI-based method 800 includes detecting a set of emotions associated with each of the set of students based on the received learning data by using the education management-based AI model. In an embodiment of the present disclosure, the set of emotions are detected on a continuous basis in real-time. In an embodiment of the present disclosure, the set of emotions are detected by analyzing the one or more real-time images, the one or more real-time videos and the one or more videos of each of the set of students captured by the one or more cameras placed methodically by using the education management-based AI model. In an exemplary embodiment of the present disclosure, the set of emotions include happy, sad, anger, contempt, disgust, fear, surprise, cry, laugh, scared, confusion, excitement and the like. In an embodiment of the present disclosure, the set of emotions are timestamped and stored in the storage unit. Further, the AI-based method 800 includes determining the one or more emotional issues associated with the detected set of issues based on the received learning data, the detected set of emotions and a set of predefined emotion rules by using the education management-based AI model in real-time. In an embodiment of the present disclosure, the one or more emotional issues are emotions which are bound to create health issues among students. For example, the one or more emotional issues include anxiety disorder, behavioral and emotional disorders, bipolar affective disorder, depression and the like. Furthermore, the AI-based method 800 includes outputting the detected set of emotions and the determined one or more emotional issues on user interface screen of the one or more electronic devices 108 associated with the one or more users in real-time.

In an embodiment of the present disclosure, the AI-based method 800 includes identifying the set of students and the one or more teachers in the one or more real-time images, the one or more real-time videos, the one or more real-time audios or any combination thereof of each of the set of students and the one or more teachers by using the education management-based AI model. Further, the AI-based method 800 includes identifying the one or more objects in the one or more real-time images, the one or more real-time videos or a combination thereof of the one or more objects by using the education management-based AI model. In an exemplary embodiment of the present disclosure, the one or more objects comprise modals, presentations, charts, black board and the like. Further, the AI-based method 800 includes converting the one or more real-time audios into a set of keywords by using the education management-based AI model. In an embodiment of the present disclosure, the one or more real-time audios are processed to extract the set of keywords using RNN based AI Models, speech to text engines and the like. The AI-based method 800 includes determining the set of interaction parameters based on the received learning data, the identified set of students, the identified one or more teachers, the set of keywords and the identified one or more objects by using the education management-based AI model. In an exemplary embodiment of the present disclosure, the set of interaction parameters include number of questions asked by the one or more teachers, number of students who tried to answer, a set of responses of questions received from the set of students, number of students who raised hand, set of emotions associated with each of the set of students, action performed by the set of students, the set of activities performed by the one or more teachers, number of responses that are relevant, number of student names called by the one or more teachers, duration of eye contact, number of times students detected on stage i.e., teacher location, facial direction of the set of students and one or more teachers, duration of students on stage i.e., teacher location and the like. In an embodiment of the present disclosure, video and images are processed using Convolutional Neural Network (CNN) based AI Models to detect information of interest, such as the set of interaction parameters. For example, the actions performed by the set of students may be sleeping, talking and the like. The AI-based method 800 includes determining engagement factor of each of the set of students by assigning a score and weightage to each of the determined set of interaction parameters based on a set of predefined interaction rules by using the education management-based AI model in real-time. Further, the AI-based method 800 includes classifying each of the set of students in one or more engagement categories based on the determined engagement factor and predefined engagement information in real-time. The predefined engagement information corresponds a pre-decided benchmark set by an educational institute to classify each of the set of students in the one or more engagement categories. In an exemplary embodiment of the present disclosure, the one or more engagement categories include low engagement, high engagement, average engagement and the like. In an embodiment of the present disclosure, the determined engagement factor and the classified set of students are outputted on user interface screen of the one or more electronic devices 108 associated with the one or more users in real-time. For example, the one or more teachers are notified about low engaged students to call to action. The is action is subsequently verified for a name call of the person student of interest. In an embodiment of the present disclosure, the engagement factor provides information about subject weakness of individual students and is also vital to understand weakness of incorporated education facility. In an embodiment of the present disclosure, red flag cases such as, abnormal social interactions, distress, bullying, and the like are determined based on the one the set of interaction parameters by using the education management-based AI model.

In an embodiment of the present disclosure, the real time images or videos of each of the set of students via webcams in the online mode or the classroom cameras is analysed by machine learning models to identify the engagement factor of each of the one or more students. In such embodiment, real time test evaluation data for selected students of the one or more students provide added details of the engagement factor of such selected students. In another embodiment, the analysis of the interaction details of each of the set of students provides information about subject weakness.

Further, the AI-based method 800 includes generating one or more personalized content for each of one or more students with low engagement based on the set of interaction parameters, the determined engagement factor and a set of predefined content information by using the education management-based AI model. In an exemplary embodiment of the present disclosure, the one or more personalized content include assignment, study material, a set of contextual questions and quizzes based on the engagement factor, contextual subject audio, video and text and the like. In an embodiment of the present disclosure, the one or more personalized content is generated to improve subject weakness of students. Further, the one or more personalized content may be used by each of the one or more teachers to understand pop-quiz questions to be presented to each of the set of students, which helps in reengaging the one or more students back to their learning. Each of the one or more teachers also understands the customization required in the course work to reengage each of the one or more students back to learning. Furthermore, each of the one or more teachers may also evaluate the social skills of each of the one or more students based on the engagement factor.

Furthermore, the AI-based method 800 includes receiving a set of images and videos associated with the one or more teachers from one or more teacher cameras. In an embodiment of the present disclosure, the one or more teacher cameras are cameras facing the one or more teachers. Further, the AI-based method 800 includes receiving a set of images and videos associated with the set of students from one or more student cameras. In an embodiment of the present disclosure, the one or more student cameras are cameras facing the set of students. The set of images and videos associated with the set of students and the set of images and videos associated with the one or more teachers are captured on a time-synced basis to measure relative head pose of student. The AI-based method 800 includes determining the set of teacher parameters based on the received set of images and videos associated with the one or more teachers by using the education management-based AI model. In an exemplary embodiment of the present disclosure, the set of teacher parameters include teacher detection, location coordinates of the one or more teachers and the like. The AI-based method 800 includes determining a set of student parameters based on the received set of images and videos associated with the set of students by using the education management-based AI model. In an exemplary embodiment of the present disclosure, the set of student parameters include student identity, head orientation angle of the set of students and the like. Furthermore, the AI-based method 800 includes calibrating student location 0 deg head orientation angle against angle of teacher location in teacher camera based on the determined set of teacher parameters, the determined set of student parameters and a set of predefined calibration rules. For example, a student's correction angle for straight position is equal to angle of correction from teacher camera. The AI-based method 800 includes determining actual head angle of each of the set of students to determine engagement of the student in the classroom based on the determined set of teacher parameters and the determined set of student parameters by using the education management-based AI model upon calibration in real-time. For example, on two separate time synced images, position of the teacher in image is extracted and head pose of student is extracted. Each student location 0 deg head orientation (straight) is calibrated against the angle of teacher location in teacher camera. Student A correction angle for straight position is equal to angle of correction from teacher camera. Using correction angle, actual head angle of the student is determined to figure if student is oriented towards the teacher.

The AI-based method 800 may be implemented in any suitable hardware, software, firmware, or combination thereof.

Thus, various embodiments of the present AI-based computing system 104 provide a solution to manage education of students in real-time. The AI-based computing system 104 facilitates in achieving revenue continuity, strategic cost reduction, ensuring accountability and highest teaching standards and safety of students at school as per policy. Further, the AI-based computing system 104 increases the productivity of teachers without compromising on regular functioning and ensure effectiveness of the pedagogy in both classroom and online learning mode. Furthermore, the AI-based computing system 104 helps to achieve this by using the AI and machine learning based cutting-edge technology, facial recognition, and emotion AI techniques. In an embodiment of the present disclosure, the AI-based computing system 104 assesses student attentiveness (both in classroom and online), effectiveness and productivity of the teachers, suggests improvement in pedagogy, provides appropriate data driven levers to the school administration to control costs, allows administrators to mitigate risks from loss of revenue and also reputation using inbuilt AI-based campus security tool. The AI-based computing system 104 provides content rich, data driven, on-demand and scheduled analytical reports, visualizations, intelligent suggestions based on inferences derived from the incoming data streams like audio/video from the cameras installed in the classroom and/or audio/video coming in from students/teachers webcam used for online sessions. Furthermore, the AI-based computing system 104 also integrates with major conferencing products used for online training like Zoom, Microsoft teams to gather information about the sessions and analyse. This allows schools to evaluate performance of teachers and students by behaviour analysis techniques, generates customized assignments to each student automatically, and complements the teachers by suggesting revisions on topics, students that need extra attention, alerts during lectures to keep more engagement. The AI-based computing system 104 allows formulation of SOP for the each of the one or more teachers. In one embodiment of the present disclosure, the analysis also provides information about lagging students, such that each of the one or more teachers may take special care of such lagging students. The one or more student guardians gets information about the concerned student attendance details. The AI-based computing system 104 measures attentiveness of the students by identifying attentiveness levels of individual students and the class in general, which student should be approached for cold calling, generating pop quizzes and selecting target students who have low attentiveness level to re-engage them into the class. Furthermore, the AI-based computing system 104 maintains discipline by identifying red flag cases to take appropriate action. The AI-based computing system 104 maintains student engagement as it determines when to stop the lecture to repeat any topic (and which topic to repeat), customised assignments based on individual requirements, suggest change in pedagogy and also hand out customised assignments/pop quizzes based on the attentiveness levels. The AI-based computing system 104 identifies laggards, data associated with student performance for parent-teacher meetings and provide inputs on social skills.

Further, the AI-based computing system 104 receives red flags reports on usual activity and behaviour to take appropriate actions. The AI-based computing system 104 automates attendance at any time on the session or day. Furthermore, the AI-based computing system 104 improves ward performance by identifying weak areas, identifying whether the ward requires individual attention from teachers, identifying whether the ward is getting the required individual attention and monitor performance over a period of time. The AI-based computing system 104 may assess the behaviour patterns by analysing the nature of interaction of the ward with others. The AI-based computing system 104 may enhance security by reducing threat/risk perception. Since the attendance is automated now using facial recognition, parents can know the whereabouts of their ward. Further, red-flag cases are identified, and messages are sent to class teachers or designated stakeholders in real time. Attendance is integrated with temperature measuring devices. Red flag incidents are identified in the school bus. Furthermore, the AI-based computing system 104 makes performance appraisal more objective and transparent as it compares performance of teachers teaching the same subject and compare their respective engagement levels, adherence to SOPs, discipline levels, and any other parameter set by the administration. The AI-based computing system 104 measures the attentiveness and behavioural patterns using facial recognition. This helps in understanding the patterns between content and attentiveness/engagement levels. This data is used to suggest changes in part of the content and pedagogy. Further, the AI-based computing system 104 enables integration with existing LMS utilised by the institution. Further, since the product itself stores the data, over a period of time. The AI-based computing system 104 may also assume the role of an LMS. The AI-based computing system 104 allows the school to identify and focus on the laggards. Students who avoid questions by remaining inconspicuous, students who are afraid to clarify doubts due to fear of embarrassment, and so on. Thus, focusing on these laggards would allow the school to improve its average performance figures drastically. Further, the AI-based computing system 104 also allows schools to redefine metrics for success—schools would be proudly able to announce how many of their students scored over, say 80% marks rather than just advertise the pass %, as is the common practice currently. The AI-based computing system 104 includes inbuilt techniques to identify a student of staff in distress by comparing their facial expressions, their proximity to unidentified individuals, their behaviour during interaction with known persons and the location of the event.

Furthermore, the AI-based computing system 104 identifies the students whose attentiveness has dropped below a pre-decided benchmark set by the educational institute. The AI-based computing system 104 notifies the names of the students with low attentiveness levels and the attentiveness level of the class in general to the teacher in real time. This enables the teacher to take immediate steps to reengage the kids in the classroom session. The AI-based computing system 104 also assists the teachers in this activity by automatically handing out pop up quizzes and re-engagement notices to such students. Further, the teachers can look at the results to identify the students' areas of improvement and decide to create an action plan required to improve the student performance. The AI-based computing system 104 aids the teachers to define the action plan and over a period of time use techniques to start suggesting a good action plan and provide tools with which to execute them (such as generate pop quizzes etc). This information can also be provided to the parents and students on their application to provide an early warning system, thus equipping them to identify and address the issue in a proactive manner In addition to storing those individual incidents or events, the AI-based computing system 104 may also employ techniques to understand and learn if there is a pattern to this behaviour that can be drawn. The behaviour pattern analysis may be stored over a period to help teachers and parents better prepared to identify the trajectory of student performance. The information may also be utilised to facilitate effective Parent Teacher Association (PTA) meetings.

Further, the AI-based computing system 104 identifies student behavioural and psychological health. The AI-based computing system 104 enables detection of tell-tale signs of depression or stress—staying aloof, irritability, minimal social interaction which is limited to few people, and any other behaviour patterns identified by psychologists. The AI-based computing system 104 uses machine learning models to pick up incidents having potential to escalate by analysing the context of interaction between the individuals involved. Furthermore, the AI-based computing system 104 may capture events that will be termed as red flags or early warnings that tells to detect anomalies in student behaviour.

For example, the AI-based computing system 104 may run predictive analysis to determine if the student behaviour is conforming to the pattern of a bully or if it was a one-off occurrence. Certain repeated aggressive behaviours or alternatively behaviours that are outside those defined as ‘normal’ would be flagged. These inputs would be available for the school counsellors and the class teachers so that proactive steps can be taken to prevent any serious events from occurring. The school administration may define the quality parameters for the teachers to follow. For example, time spent on instructional aids like black board/props, Q&A sessions, individual interaction with students, etc. The same can be monitored by the AI-based computing system 104, thereby helping the administration in ensuring quality of instruction. Thus, the AI-based computing system 104 allows educational institutions to identify and focus on the section of students who need additional attention from teachers, thereby improving the average performance of the institute. While doing this, it also allows the school to define and ensure the quality standards to be followed. The AI-based computing system 104 also mitigates the security related risks by predicting or identifying potential “red flag” cases.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. An Artificial intelligence (AI)-based computing system for managing education of students in real-time, the AI based computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data receiver module configured to receive learning data associated with at least one of: online mode and offline mode of classroom from at least one of: one or more data capturing devices and media streams, wherein the learning data comprises at least one of: one or more real-time images, one or more real-time videos and one or more real-time audios of each of a set of students, one or more teachers and one or more objects and real-time location coordinates of each of the set of students, the one or more teachers and the one or more objects;
an activity detection module configured to detect a set of activities performed by each of the set of students and the one or more teachers based on the received learning data by using an education management-based AI model;
an activity classification module configured to classify the determined set of activities associated with the set of students in one of: one or more attention activities and one or more non-attention activities based on the received learning data and a set of thresholds by using the education management-based AI model;
a parameter determination module configured to determine a set of contextual parameters corresponding to the detected set of activities based on the one or more real-time audios associated with the one or more teachers by using the education management-based AI model upon classifying the determined set of activities, wherein the set of contextual parameters comprise: standard of the set of students, subject, chapter, topic and sub-topic which the one or more teachers are teaching in the classroom;
a learning gap identification module configured to identify one or more learning gaps in one or more students among the set of students based on the received learning data, the one or more non-learning activities, the set of activities performed by the one or more teachers and the determined set of contextual parameters by using the education management-based AI model in real-time, wherein the one or more learning gaps correspond to topic clear to students, topic not clear to students, number of the students, contextual parameters and time duration in which the students faced difficulty while learning in the classroom; and
a data output module configured to output the one or more attention activities, the one or more non-attention activities, the determined set of contextual parameters and the identified one or more learning gaps on user interface screen of one or more electronic devices associated with one or more users in real-time, wherein the one or more users comprise: the one or more teachers and one or more guardians of the one or more students, one or more administrative employees and one or more psychologists.

2. The AI-based computing system of claim 1, wherein in classifying the determined set of activities associated with the set of students in one of: the one or more attention activities and the one or more non-attention activities based on the received learning data and the set of thresholds by using the education management-based AI model, the activity classification module is configured to:
normalize the detected set of activities by performing normalization technique on the detected set of activities, wherein the normalized set of activities are timestamped to store the normalized set of activities in a timeseries structure in a storage unit;
compare the detected set of activities with the set of thresholds parameters by using the education management-based AI model upon normalizing the detected set of activities; and
classify the determined set of activities in one of: the one or more attention activities and the one or more non-attention activities based on the received learning data and the result of comparison by using the education management-based AI model.

3. The AI-based computing system of claim 1, wherein in determining the set of contextual parameters corresponding to the detected set of activities based on the one or more real-time audios associated with the one or more teachers by using the education management-based AI model upon classifying the determined set of activities, the parameter determination module is configured to:
detect language of teaching used in the one or more real-time audios associated with the one or more teachers by using the education management-based AI model;
convert the one or more real-time audios associated with the one or more teachers into Unicode text based on the detected language by using the education management-based AI model;
convert the Unicode text into English text paragraph by using the education management-based AI model; and
determine the set of contextual parameters corresponding to the detected set of activities based on the English text paragraph by using the education management-based AI model, wherein the set of contextual parameters are stored in a storage unit with source timestamps in the one or more real-time audios associated with the one or more teachers.

4. The AI-based computing system of claim 3, wherein in determining the set of contextual parameters corresponding to the detected set of activities based on the English text paragraph by using the education management-based AI model, the parameter determination module is configured to:
detect the standard of the set of students based on the English text paragraph by using the education management-based AI model;
determine the subject of teaching based on the detected standard of the set of students and the English text paragraph by using the education management-based AI model;
detect the chapter of the subject based on the detected standard of the set of students, the English text paragraph and the determined subject by using the education management-based AI model;
detect the topic of the chapter based on the detected standard of the set of students, the English text paragraph, the determined subject and the detected chapter by using the education management-based AI model; and
determine the sub-topic associated with the topic based on the detected standard of the set of students, the English text paragraph, the determined subject, the detected chapter and the detected topic by using the education management-based AI model.

5. The AI-based computing system of claim 1, further comprises a posture management module configured to:
detect a set of posture parameters associated with the set of students and the one or more teachers based on the received data by using the education management-based AI model, wherein the set of posture parameters comprise: neck bend, spine bend, bend in standing position, bend in walking position, arm bend angle, wrist bend angle, viewing distance from electronic screens, break count and duration and wherein each of the set of posture parameters are timestamped and stored in a storage unit;
determine one or more posture issues with ergonomics of the set of students and the one or more teachers based on the detected set of postures and a set of predefined posture rules by using the education management-based AI model in real-time;
determine one or more corrective measures corresponding to the one or more issues based on the determined one or more posture issues and predefined corrective information by using the education management-based AI model, wherein the one or more corrective measures comprise: correcting the pose, taking a walk break and performing one or more actions; and
generate one or more alerts corresponding to the determined one or more posture issues and the determined one or more corrective measures in real-time, wherein the generated one or more alerts are outputted on user interface screen of the one or more electronic devices associated with the one or more users.

6. The AI-based computing system of claim 1, further comprises an emotion determination module configured to:
detect a set of emotions associated with each of the set of students based on the received learning data by using the education management-based AI model, wherein the set of emotions comprise: happy, sad, anger, contempt, disgust, fear, surprise, cry, laugh, scared, confusion and excitement and wherein the set of emotions are timestamped and stored in a storage unit; and
determine one or more emotional issues associated with the detected set of emotions based on the received learning data, the detected set of emotions and a set of predefined emotion rules by using the education management-based AI model in real-time; and
output the detected set of emotions and the determined one or more emotional issues on user interface screen of the one or more electronic devices associated with the one or more users in real-time.

7. The AI-based computing system of claim 1, further comprises interaction management module configured to:
identify the set of students and the one or more teachers in at least one of: the one or more real-time images, the one or more real-time videos and the one or more real-time audios of each of the set of students and the one or more teachers by using the education management-based AI model;
identify the one or more objects in at least one of: the one or more real-time images and the one or more real-time videos of the one or more objects by using the education management-based AI model, wherein the one or more objects comprise: modals, presentations, charts and black board;
convert the one or more real-time audios into a set of keywords by using the education management-based AI model;
determine a set of interaction parameters based on the received learning data, the identified set of students, the identified one or more teachers, the set of keywords and the identified one or more objects by using the education management-based AI model, wherein the set of interaction parameters comprise: number of questions asked by the one or more teachers, number of students who tried to answer, a set of responses of questions received from the set of students, number of students who raised hand, set of emotions associated with each of the set of students, action performed by the set of students, the set of activities performed by the one or more teachers, number of responses that are relevant, number of student names called by the one or more teachers, duration of eye contact, number of times students detected on stage, facial direction of the set of students and one or more teachers and duration of students on stage;
determine engagement factor of each of the set of students by assigning a score and weightage to each of the determined set of interaction parameters based on a set of predefined interaction rules by using the education management-based AI model in real-time; and
classify each of the set of students in one or more engagement categories based on the determined engagement factor and predefined engagement information in real-time, wherein the one or more engagement categories comprise: low engagement, high engagement and average engagement, wherein the determined engagement factor and the classified set of students are outputted on user interface screen of the one or more electronic devices associated with the one or more users in real-time.

8. The AI-based computing system of claim 7, further comprises a content generation module configured to generate one or more personalized content for each of one or more students with low engagement based on the set of interaction parameters, the determined engagement factor and a set of predefined content information by using the education management-based AI model, wherein the one or more personalized content comprise: assignment, study material, a set of contextual questions and quizzes based on the engagement factor, contextual subject audio, video and text.

9. The AI-based computing system of claim 1, further comprises an engagement determination module configured to:
receive a set of images and videos associated with the one or more teachers from one or more teacher cameras, wherein the one or more teacher cameras are cameras facing the one or more teachers;
receive a set of images and videos associated with the set of students from one or more student cameras, wherein the one or more student cameras are cameras facing the set of students;
determine a set of teacher parameters based on the received set of images and videos associated with the one or more teachers by using the education management-based AI model, wherein the set of teacher parameters comprise: teacher detection and location coordinates of the one or more teachers;
determine a set of student parameters based on the received set of images and videos associated with the set of students by using the education management-based AI model, wherein the set of student parameters comprise: student identity and head orientation angle of the set of students;
calibrate student location 0 deg head orientation angle against angle of teacher location in teacher camera based on the determined set of teacher parameters, the determined set of student parameters and a set of predefined calibration rules; and
determine actual head angle of each of the set of students to determine engagement of the student in the classroom based on the determined set of teacher parameters and the determined set of student parameters by using the education management-based AI model upon calibration in real-time.

10. The AI-based computing system of claim 1, wherein in identifying the one or more learning gaps in the one or more students based on the received learning data, the one or more non-learning activities, the set of activities performed by the one or more teachers and the determined set of contextual parameters by using the education management-based AI model in real-time, the learning gap identification module is configured to:
correlate the one or more non-learning activities with the determined set of contextual parameters by using the education management-based AI model; and
identify the one or more learning gaps in the one or more students based on the received learning data, the set of activities performed by the one or more teachers and result of correlation by using the education management-based AI model in real-time.

11. The AI-based computing system of claim 1, further comprises a recommendation generation module configured to:
detect one or more reasons for the one or more non-attention activities based on the received learning data, the one or more non-learning activities, the set of activities performed by the one or more teachers, the determined set of contextual parameters and a set predefined attention rules by using the education management-based AI model, wherein the one or more reasons comprise: talking with students, confused, sleeping, playing in the classroom, over-choice of learning aid, social skill level and behavioural patterns of each of set of the one or more students, Statement of Procedures (SOPs) and performance details of each of the one or more teachers; and
generate one or more recommendations to reduce the one or more learning gaps based on the received learning data, the one or more non-learning activities, the set of activities performed by the one or more teachers, the determined set of contextual parameters, predefined recommendation information and the detected one or more reasons by using the education management-based AI model in real-time, wherein the one or more recommendations comprise: changing pedagogy, training the one or more teachers, sharing the detected one or more reasons with the one or more users, generating a customized content for the one or more students and assigning learning priority to each of the set of students based on the one or more learning gaps.

12. An AI-based method for managing education of students in real-time, the AI based method comprising:
receiving, by one or more hardware processors, learning data associated with at least one of: online mode and offline mode of classroom from at least one of: one or more data capturing devices and media streams, wherein the learning data comprises at least one of: one or more real-time images, one or more real-time videos and one or more real-time audios of each of a set of students, one or more teachers and one or more objects and real-time location coordinates of each of the set of students, the one or more teachers and the one or more objects;
detecting, by the one or more hardware processors, a set of activities performed by each of the set of students and the one or more teachers based on the received learning data by using an education management-based AI model;
classifying, by the one or more hardware processors, the determined set of activities associated with the set of students in one of: one or more attention activities and one or more non-attention activities based on the received learning data and a set of thresholds by using the education management-based AI model;
determining, by the one or more hardware processors, a set of contextual parameters corresponding to the detected set of activities based on the one or more real-time audios associated with the one or more teachers by using the education management-based AI model upon classifying the determined set of activities, wherein the set of contextual parameters comprise: standard of the set of students, subject, chapter, topic and sub-topic which the one or more teachers are teaching in the classroom;
identifying, by the one or more hardware processors, one or more learning gaps in one or more students among the set of students based on the received learning data, the one or more non-learning activities, the set of activities performed by the one or more teachers and the determined set of contextual parameters by using the education management-based AI model in real-time, wherein the one or more learning gaps correspond to topic clear to students, topic not clear to students, number of the students, contextual parameters and time duration in which the students faced difficulty while learning in the classroom; and
outputting, by the one or more hardware processors, the one or more attention activities, the one or more non-attention activities, the determined set of contextual parameters and the identified one or more learning gaps on user interface screen of one or more electronic devices associated with one or more users in real-time, wherein the one or more users comprise: the one or more teachers and one or more guardians of the one or more students, one or more administrative employees and one or more psychologists.

13. The AI-based method of claim 12, wherein classifying the determined set of activities associated with the set of students in one of: the one or more attention activities and the one or more non-attention activities based on the received learning data and the set of thresholds by using the education management-based AI model comprises:
normalizing the detected set of activities by performing normalization technique on the detected set of activities, wherein the normalized set of activities are timestamped to store the normalized set of activities in a timeseries structure in a storage unit;
comparing the detected set of activities with the set of thresholds parameters by using the education management-based AI model upon normalizing the detected set of activities; and
classifying the determined set of activities in one of: the one or more attention activities and the one or more non-attention activities based on the received learning data and the result of comparison by using the education management-based AI model.

14. The AI-based method of claim 12, wherein determining the set of contextual parameters corresponding to the detected set of activities based on the one or more real-time audios associated with the one or more teachers by using the education management-based AI model upon classifying the determined set of activities comprises:
detecting language of teaching used in the one or more real-time audios associated with the one or more teachers by using the education management-based AI model;
converting the one or more real-time audios associated with the one or more teachers into Unicode text based on the detected language by using the education management-based AI model;
converting the Unicode text into English text paragraph by using the education management-based AI model; and
determining the set of contextual parameters corresponding to the detected set of activities based on the English text paragraph by using the education management-based AI model, wherein the set of contextual parameters are stored in a storage unit with source timestamps in the one or more real-time audios associated with the one or more teachers.

15. The AI-based method of claim 14, wherein determining the set of contextual parameters corresponding to the detected set of activities based on the English text paragraph by using the education management-based AI model comprises:
detecting the standard of the set of students based on the English text paragraph by using the education management-based AI model;
determining the subject of teaching based on the detected standard of the set of students and the English text paragraph by using the education management-based AI model;
detecting the chapter of the subject based on the detected standard of the set of students, the English text paragraph and the determined subject by using the education management-based AI model;
detecting the topic of the chapter based on the detected standard of the set of students, the English text paragraph, the determined subject and the detected chapter by using the education management-based AI model; and
determining the sub-topic associated with the topic based on the detected standard of the set of students, the English text paragraph, the determined subject, the detected chapter and the detected topic by using the education management-based AI model.

16. The AI-based method of claim 12, further comprises:
detecting a set of posture parameters associated with the set of students and the one or more teachers based on the received data by using the education management-based AI model, wherein the set of posture parameters comprise: neck bend, spine bend, bend in standing position, bend in walking position, arm bend angle, wrist bend angle, viewing distance from electronic screens, break count and duration and wherein each of the set of posture parameters are timestamped and stored in a storage unit;
determining one or more posture issues with ergonomics of the set of students and the one or more teachers based on the detected set of postures and a set of predefined posture rules by using the education management-based AI model in real-time;
determining one or more corrective measures corresponding to the one or more issues based on the determined one or more posture issues and predefined corrective information by using the education management-based AI model, wherein the one or more corrective measures comprise: correcting the pose, taking a walk break and performing one or more actions; and
generating one or more alerts corresponding to the determined one or more posture issues and the determined one or more corrective measures in real-time, wherein the generated one or more alerts are outputted on user interface screen of the one or more electronic devices associated with the one or more users.

17. The AI-based method of claim 12, further comprises:
detecting a set of emotions associated with each of the set of students based on the received learning data by using the education management-based AI model, wherein the set of emotions comprise: happy, sad, anger, contempt, disgust, fear, surprise, cry, laugh, scared, confusion and excitement and wherein the set of emotions are timestamped and stored in a storage unit; and
determining one or more emotional issues associated with the detected set of emotions based on the received learning data, the detected set of emotions and a set of predefined emotion rules by using the education management-based AI model in real-time; and
outputting the detected set of emotions and the determined one or more emotional issues on user interface screen of the one or more electronic devices associated with the one or more users in real-time.

18. The AI-based method of claim 12, further comprises:
identifying the set of students and the one or more teachers in at least one of: the one or more real-time images, the one or more real-time videos and the one or more real-time audios of each of the set of students and the one or more teachers by using the education management-based AI model;
identifying the one or more objects in at least one of: the one or more real-time images and the one or more real-time videos of the one or more objects by using the education management-based AI model, wherein the one or more objects comprise: modals, presentations, charts and black board;
converting the one or more real-time audios into a set of keywords by using the education management-based AI model;
determining a set of interaction parameters based on the received learning data, the identified set of students, the identified one or more teachers, the set of keywords and the identified one or more objects by using the education management-based AI model, wherein the set of interaction parameters comprise: number of questions asked by the one or more teachers, number of students who tried to answer, a set of responses of questions received from the set of students, number of students who raised hand, set of emotions associated with each of the set of students, action performed by the set of students, the set of activities performed by the one or more teachers, number of responses that are relevant, number of student names called by the one or more teachers, duration of eye contact, number of times students detected on stage, facial direction of the set of students and one or more teachers and duration of students on stage;
determining engagement factor of each of the set of students by assigning a score and weightage to each of the determined set of interaction parameters based on a set of predefined interaction rules by using the education management-based AI model in real-time; and
classifying each of the set of students in one or more engagement categories based on the determined engagement factor and predefined engagement information in real-time, wherein the one or more engagement categories comprise: low engagement, high engagement and average engagement, wherein the determined engagement factor and the classified set of students are outputted on user interface screen of the one or more electronic devices associated with the one or more users.

19. The AI-based method of claim 18, further comprises generating one or more personalized content for each of one or more students with low engagement based on the set of interaction parameters, the determined engagement factor and a set of predefined content information by using the education management-based AI model, wherein the one or more personalized content comprise: assignment, study material, a set of contextual questions and quizzes based on the engagement factor, contextual subject audio, video and text.

20. The AI-based method of claim 12, further comprises:
receiving a set of images and videos associated with the one or more teachers from one or more teacher cameras, wherein the one or more teacher cameras are cameras facing the one or more teachers;
receiving a set of images and videos associated with the set of students from one or more student cameras, wherein the one or more student cameras are cameras facing the set of students;
determining a set of teacher parameters based on the received set of images and videos associated with the one or more teachers by using the education management-based AI model, wherein the set of teacher parameters comprise: teacher detection and location coordinates of the one or more teachers;
determining a set of student parameters based on the received set of images and videos associated with the set of students by using the education management-based AI model, wherein the set of student parameters comprise: student identity and head orientation angle of the set of students;
calibrating student location 0 deg head orientation angle against angle of teacher location in teacher camera based on the determined set of teacher parameters, the determined set of student parameters and a set of predefined calibration rules; and
determining actual head angle of each of the set of students to determine engagement of the student in the classroom based on the determined set of teacher parameters and the determined set of student parameters by using the education management-based AI model upon calibration in real-time.

21. The AI-based method of claim 12, wherein identifying the one or more learning gaps in the one or more students based on the received learning data, the one or more non-learning activities, the set of activities performed by the one or more teachers and the determined set of contextual parameters by using the education management-based AI in real-time comprises:
correlating the one or more non-learning activities with the determined set of contextual parameters by using the education management-based AI model; and
identifying the one or more learning gaps in the one or more students based on the received learning data, the set of activities performed by the one or more teachers and result of correlation by using the education management-based AI model in real-time.

22. The AI-based method of claim 12, further comprises:
detecting one or more reasons for the one or more non-attention activities based on the received learning data, the one or more non-learning activities, the set of activities performed by the one or more teachers, the determined set of contextual parameters and a set predefined attention rules by using the education management-based AI model, wherein the one or more reasons comprise: talking with students, confused, sleeping, playing in the classroom, over-choice of learning aid, social skill level and behavioural patterns of each of set of the one or more students, adherence to SOPs by teachers and performance details of each of the one or more teachers; and
generating one or more recommendations to reduce the one or more learning gaps based on the received learning data, the one or more non-learning activities, the set of activities performed by the one or more teachers, the determined set of contextual parameters, predefined recommendation information and the detected one or more reasons by using the education management-based AI model in real-time, wherein the one or more recommendations comprise: changing pedagogy, training the one or more teachers, sharing the detected one or more reasons with the one or more users, generating a customized content for the one or more students and assigning learning priority to each of the set of students based on the one or more learning gaps.
